(19) United States
(12) Patent Application Publication
(10) Pub. No.: US 2025/0279454 A1
(43) Pub. Date: Sep. 4, 2025

(54) Large-Area Solid Oxide Micro-Cell

(71) Applicant: Donald Hilliard, tucson, AZ (US)

(72) Inventor: Donald Hilliard, tucson, AZ (US)

(21) Appl. No.: 19/011,655

(22) Filed: Jan. 7, 2025

Related U.S. Application Data
(60) Provisional application No. 63/618,367, filed on Jan. 7, 2024.

(51) Int. Cl. H01M 8/1226; C25B 9/60; H01M 8/04089; H01M 8/12; H01M 8/1231; H01M 8/2432; H01M 8/2457; H01M 8/2483

(52) U.S. Cl. CPC H01M 8/1226; C25B 9/60; H01M 8/04104; H01M 8/1231; H01M 8/2432; H01M 8/2457; H01M 8/2483; H01M 2008/1293

(57) ABSTRACT

A primary objective of the present invention is solid-oxide cell structures, interconnect structures, stack structures, and methods that symbiotically maximize durability, scaled manufacturability, device efficiency, and cost-efficiency for large area cell structures, particularly for Intermediate-temperature (IT) Solid-Oxide-Cell and Low-Temperature-Solid-Oxide-Cell applications, wherein rolled-alloy-based micro-cells are formed in dense arrays.

### FIELD OF THE INVENTION

The present invention relates to electrolyzers, fuel cells and related systems. This application is related to and utilizes contents of U.S. Pat. No. 7,879,474 and U.S. patent application Ser. No. 11/906,044 of sole inventorship by the same author, which are included herein by reference in their entirety.

### SUMMARY OF THE INVENTION

Large Area Cell Structures: A primary objective of the present invention is SOC cell structures, interconnect structures, stack structures, and methods that symbiotically maximize durability, scaled manufacturability, device efficiency, and cost-efficiency for large area cell structures, particularly for IT-SOC and LT-SOC applications, wherein rolled-alloy-based micro-cells are formed in dense arrays.

High Pressure operation: Another objective of the present inventions is operation of a reversible or non-reversible micro-SOC system at higher static and turbulent gas pressure differentials adjacent to and across electrode/electrolyte structures than is possible in earlier micro-SOC and SOC designs having a normal areal cell density and power density.

Another objective of the present invention is a capability for operation at higher pressure differentials across electrode/electrolyte structures through means of implementing central micro-disk-electrode structures at each micro-cell that provide a mechanically-reinforcing interconnect function

Another objective of the present invention is a capability for operation at higher pressure differentials and total pressures across electrode/electrolyte structures through specific circular peripheral interconnection structures disposed in a mechanically-robust load-spreading geometry.

Another objective of the present invention is a capability for structural/compositional attributes wherein asymptotic interconnections structures provide greater resistance to condensate formation and non-uniform condensate modification of electrode/electrolyte surface chemistry by means of greater obscuration of an asymptotic joining structure of electrolyte to support grid.

HAFTA claim for high Pressure: Another objective of the present inventions is the capability to operate at higher pressure differentials across electrode/electrolyte structures by means of a “quasi-space-frame” type thin film aspects wherein opposing paired corrugated thin-film structures are disposed so as to form a symmetric annular cavity between chemically-active surface layers formed over metallic corrugated grid structures

Another objective of the present invention is the capability to operate at higher pressure differentials by means of a roughly mirrored corrugated structure forming a roughly planar-annular cavity wherein opposing corrugated electrode/electrolyte surfaces integrated within the corrugated structures are forming the cavity, such that the resulting pair of supporting corrugated structures is thereby disposed so as to provide substantially identical catalytic surface chemistry, the catalytic surface chemistry disposed so as to interact catalytically with a gas within the cavity.

High-Pressure Structure: Another embodiment of the invention compounds the high-pressure/high-cycling embodiments introduced in conjunction with the micro-cell-level microstructure improvements of the, preferably alloy-foil-supported, electrode/electrolyte assembly by way of a higher-scale twinned quasi-space-frame, annular arrangement of the overall all cell/stack construction.

Power Density: Yet another objective of the present invention is higher power density enabled through greater thermo-mechanical load resistance through larger-radii and higher-continuity electrolyte surfaces through dimensional control of a support structure in a corrugated micro-SOC cell configuration.

Yet another objective of the present invention is a combination of higher power density, pressure-differentials, and thermo-mechanical shock resistance through more uniform electrical contact resistance that allows both regions of external compressive forcing and free-standing electrode/electrolyte regions wherein there are no wave-form discontinuities or discontinuous waveforms such as saw-tooth or square-wave profile across a plurality of free-standing SOC micro-cells.

Yet another objective of the present invention is a combination of higher power density, pressure-differentials, and thermo-mechanical shock resistance through more uniform electrical contact resistance that allows both regions of external compressive forcing and free-standing electrode/electrolyte regions wherein the electrolyte surface and its interface is highly smooth relative to the electrode surface morphology.

Yet another objective of the present invention is higher power density at the individual cell level through a high-uniformity hierarchical contact scheme that provides a self-aligning “centipede” contact array having a micro-compliant interconnect structure at the individual cell level.

Yet another objective of the present invention is higher power density enabled through graded thickness of electrolyte, electrodes, or both. In particular, composition and layer thickness can be graded from the inner diameter (ID) to the outer diameter (OD) of the annular active SOC region of the HAFTA embodiments.

HAFTA Modules and Approach: Another primary objective of the invention in its so-named hybrid-annular-flat-tube-array (HAFTA) embodiments is comprising modular annular assemblies that enable both demountable and demountable tack assemblies wherein the modular annular assemblies are an integrated and modular assembly utilized for one cell of an assembled stack. An advantage of the approach and electronic configuration in the HAFTA embodiments is the its containment of much of the electrolyte/electrode/manifolding requirements of the cell within a stackable module, wherein a relatively simple and separate counter-electrode manifold assembly is also embodied so as to provide the counter-electrode gases, preferably the O2-rich side of the cell, to the existing and integrated counter-electrode structure of the preferably pre-sealed and integrated HAFTA module, such that the electrolyte-contacting electrode and counter-electrode catalysts and/or porous electrode layers are integrated into the HAFTA module.

An advantage that is realized in the current HAFTA embodiments is the realization of a second annular and modular component, namely an O2-manifold assembly, which is individually provided and interleaved with the HAFTA modules, wherein aligned microgrid arrays and registration surfaces allow precision alignment of anisotropic hexagonal grid arrays in the respective HAFTA and O2-manifold modules. Whereas such embodiments are particularly useful for electrolysis and particularly steam electrolysis functions, such embodiments are alternatively useful for all SOC and r-SOC applications such as conversion of C/CO/CO2.

A further objective of the HAFTA embodiments is to provide mechanically-compliant, or spring-like functionality, in a separate module, namely the O2-manifold assembly, such that the primary electrode/electrolyte function of the HAFTA module is preferably separate from any desired mechanically-compliant mechanism of predetermined restoring force and clearance-enabled displacement function, which is integrated into the separate annular O2-manifold assembly. More particularly, an inventive “micro-compliant” quasi-planar structure may be formed independently for a wide variety of micro-compliant applications wherein a predetermined and ordered (distinct from substantially disordered gauze, cellular, frit, or sponge-type materials), and preferably periodic layered array allows a largely unidirectional and well-defined displacement, with a well-defined restoring force, in a high-temperature-capable design. Micro-compliant assemblies of the present invention are particularly advantageous in such applications as the present annular SOC stacks, wherein, the limited extent of micro-compliant displacement to that of micrometer to many tens of micrometers, enables far higher control of positioning, alignment, and local spring forces of each contact point over a large area in electrical contacting between relatively high-precision surfaces, wherein the number of periodically-spaced contacting-features, or pedestals, in the micro-compliant arrays is in the thousands or even millions. It is an objective of the invention in this current embodiment that 2-layer or 4-layer modules of such micro-compliant arrays can be manufactured as independent modules useful for an array of micro-compliant applications; and preferably, also installed within dimensionally matched and rotationally-aligned/keyed recesses of the O2-manifold assembly for combination with the HAFTA-type embodiments of the present invention. In this way, the SOC stack embodiments are thus highly reconfigurable to the requirements of a large range of SOC chemistries, materials sets, operation modes, and applications.

Many SOC applications, including many of the chemistries utilized in SOEC, SOFC, and r-SOC modes of operation, include gas/vapor components that will tend to form condensates and corrosive vapors that result in modifications of surface chemistry of the metal grid-array-supported electrode/electrolyte assemblies and its adjacent interconnection structures. Such condensates and vapors can be highly varied depending upon whether the solid oxide electrolyte is utilized in conjunction with hydrocarbons, CO/CO2, or other chemistries prone to coking (carbon deposition), water formation in the form of wet steam, or any other process gas/vapor that can result in non-uniform surface modification due to preferential condensation of a by-product in the separate gas streams of the SOES. Of course, in many cases, such condensates can result in migration, diffusion, and reactions at the solid/gas interface; such unwanted modification of the surface chemistry can result in accelerated failure as well as simply lowering the efficiency of the device.

A primary objective of the present embodiment is to provide means for high differentials in the relative flow-rates and pressures experienced on either side of the MEA so as to allow high control over the kinetics of condensation and by-product residence-times on one side of the MEA. The preferred embodiment retains the high-pressure attributes of the present invention, while allowing for relatively large, shared sweep volumes in the manifold spaces adjacent to the cathode or anode structures of the MEA. This operational characteristic is provided, in the present embodiment, through means of an hybrid annular flat-tube array (HAFTA), wherein the preferably annular cells are paired in a mirrored configuration. In such a configuration, in combination with other disclosed uSOC structures of the invention, relatively high-efficiency gas flows are provided while allowing high power density; whereas, at the same time, sufficient clearance is provided in the gas-manifold system to more effectively prevent small compositional instabilities in local gas/vapor chemistry that can result in unwanted condensates and surface modifications.

Another advantage of the HAFTA embodiment is that is significantly reduces the manifold passageway and interconnect requirements while increasing gas conductance and allowing more uniform gas control. The present HAFTA embodiments provide a further advantage in that the relative asymmetry and manifold clearance on respective anode/cathode sides of any given SOES can be readily modified for flexible adaptation to different operational modes, without the need to re-tool for completely-new manifold structures and gas interconnections. Since it is typically one side of a u-SOC cell that is most sensitive to gas/vapor kinetics, such flexibility in tailoring the geometric manifold asymmetry allows for low-cost adjustment of the embodied uSOC systems for accommodating a wide range of operating conditions and gas conductance/flow needs.

An objective of the present invention in its HAFTA embodiments, in particular, as well as in its general SOC embodiments as a SOC stack of any compatible type, is that it provide a removable throttle assembly that includes a plurality of throttling elements that separately address each individual cell of the stack, wherein the array of throttling elements is preferably removable from the SOC stack without separating the stack from its endplates, without separating individual cell layers, or without disturbing or separating any sealed interface of the active cell regions. The throttling elements are operable at the temperatures of the stack, and optionally provide means for separating and removing particles of a selected size or chemistry from the incoming gas stream. In particular, the individual high-temperature throttling-element that addresses a specific cell is disposed so as to provide an effective pressure separation between a primary gas supply manifold and a cell pressure that exists within the individual cell of the stack into which the individual high-temperature throttling-element is providing the supplied gas of the supply manifold. The use of the individual throttling elements is particularly preferred in the case of steam electrolysis so as to provide a backward conductance-blocking mechanism that enables a relatively higher partial pressure of hydrogen to exist within the cell (relative to the supply manifold) whereby higher thermalization of the cell is achieved by way of the hydrogen's high thermal conductivity. The throttling mechanism is also preferred so at to provide an effective hydrogen filtration mechanism that allows one-way flow of hydrogen.

Yet another objective of the present invention in its HAFTA embodiments is to minimize cell-to-cell electrical conduction issues that may both increase galvanic corrosion processes as well as increase unwanted and parasitic voltage gradients in the region of the combustive fuel/oxidizer combination.

A primary advantage of the present invention in its HAFTA embodiments is to increase efficient transfer of gases through the stack with minimum parasitic losses due to back pressure from low-conductance passageways, as well as to provide relatively isobaric gas conditions throughout the stack.

Another objective of the present invention in its HAFTA embodiments is a SOC stack wherein mechanical stress and seal lifetime is enhanced via planar layers and metallic interconnect structures that are disposed to provide a roughly identical, either anode-side or cathode-side, chemical process on either of the opposing side of the planar layer or metallic interconnect structure.

As also embodied in the present invention plates, a further advantage and objective is the isolation of all condensate-prone gas paths (e.g., a dissociated stream of steam, carbon dioxide, or hydrocarbon) that commonly result in condensates of various condensed matter such as water, hydroxides, or carbon deposition. Such electrical isolation is achieved preferably in combination with positive sealing surfaces, inert-gas gaps separated by positive sealing surfaces, and inert-gas-purging of those inert-gas gaps, combined with real-time viscous-flow time-of-diffusion diagnostics (or, alternatively, vacuum-compatible quasi-time-of-flight diagnostics in a transition-flow or molecular-flow pressure regime).

Another objective of the present invention in its HAFTA embodiments is a SOC stack wherein the processing of steam or other condensate prone gases (such as hydrocarbons prone to carbon deposition) is completely insulated, electrically, from the O2-rich-side manifold and its surfaces.

Yet another objective of the present inventions is providing a cell/stack design that enables highly controllable gas kinetics and relatively fast-response thermal modulation for efficiently preventing and/or removing condensates on the cell interior surfaces during operation

Another objective of the present invention in its HAFTA embodiments is a demountable stack or highly configurable stack fabrication method and structure that incorporates stack-able, sealed HAFTA modules containing condensate-handling manifolds, as well as the embodied “mirrored” thin-film electrolyte layers and electrodes.

Another objective of the present invention in certain embodiments in general stack congifurations is a removable central manifold structure wherein such removal does not disturb, require disassembly, or structurally modify the surrounding SOC stack and an annular, sealed, electrolyte/electrode region.

Condensate-Prone-Gas Cell Design: A primary advantage of the present invention particularly in its HAFTA embodiments is thus ensuring structural reliability in very-thin alloy foil cross-sections by way of highly symmetric surface chemistry, thermal profile, current-density and conditioning (relative to the highly asymmetric conditions of a thin bipolar interconnect plate/manifold in a conventional SOC stack), such that the inventive hybrid annular-flat-tube array provides that each of the unconventionally-thin, mechanically-flexible interconnect layers that support the electrolyte and catalyst layers is exposed to nearly identical chemistry and surface reactions during operation; and, so that mechanical stress-strain relationships that are induced by such chemical surface modification is balanced on opposite surfaces of the thin metallic structures that form each cavity; and, such that only the relatively thin and flexible sheet that is supporting and protected by the electrolyte layer is experiencing the asymmetric gas and chemistry of opposing cathode/anode sides in the operative, energy-converting region of the SOC device. By avoiding the asymmetric chemistry of bipolar plates in a conventional SOC stack (e.g., one side in the anode environment-the opposing side in the cathode environment), such thin alloys may be rendered quite thin due to the absence of chemical potential and current density in the region of active chemistry that is normally driving galvanic corrosion on such bipolar elements.

Accordingly, an objective of the present invention is a highly-flexible SOC stack technology platform for building of high-power-density stacks of large-area-cells for handling of condensate-prone gases/vapors, such as variously composed steams, CO2 mixtures, hydrocarbon gases/vapors, and combinations thereof.

Another objective of the present invention, particularly in its various HAFTA embodiments, is to provide thin-alloy layers acting as substantially monopolar current interconnection structures in an SOEC wherein opposing sides of the alloy layers are exposed to similar reactive species and are aged or modified in their thermally-cycled surface chemistry by either both anode-side or both cathode-side chemistry, thereby reducing both the degradation by galvanic corrosion processes and reducing bulk, interface, and surface diffusion processes that are resulting from a chemical potential created by disparate surface chemistries that are experienced in conventional bipolar interconnect plates. A primary advantage of this approach is to allow very-thin alloy foils in a micro-SOC stack that are otherwise degraded by high chemical potentials of a bipolar plate configuration.

Another advantage of the present HAFTA configuration is the resulting uniformity and fast-purge modulation of passageways that aids in avoiding condensates and other local compositional fluctuations in gas phases that can produce undesirable modification of local surface chemistry and increased ohmic losses.

Another advantage of the HAFTA embodiments, in particular, utilizing a center-tap electrode reinforcement, is an Ultra-High-Density (UHD) u-SOC scheme via mirrored HAFTA arrays with >100 full cell layers per inch, or greater-than 4 cell layers/mm. In such alternative embodiments, a collective volume-specific TPB density is far higher, relative to conventional, thicker-layer-incorporating and differently configured “micro-SOC” devices. This density is also particularly providing higher volume-specific electrode area over any known calendared SOC architectures.

Another objective of the present invention is to maintain high power density/unit volume of the SOC stack while simultaneously implementing highly-dense and thin layers of the individual cells, such that each individual cell and its concomitant electrode structures are able to operate in a relatively low current density for a given volume-specific power density. Not only does this allow for a relative lowering of over-potentials and associated parasitic losses, it also allows to optionally operate in a regime of avoiding solid-state and surface-diffusion processes that are not favored in a very thin electrode wherein the TPB surface topography is a significant portion of the overall electrode; and wherein the ion conductance through each layer can be maintained at a far lower aerial current-density while maintaining the same volume-specific current density within the stack, due to far more cell layers that share the same current load.

Micro-Cell Dimensional Aspects: In another objective of the present invention, a combination of structural means have been found to synergistically provide a simultaneous improvements of the rolled-alloy-based thin-film micro-cell constructions being explored, such that great advances are made simultaneously in the durability, power-density uniformity, and application-flexibility of this approach.

An objective of the present invention regards development of inventive micro-cell structures and methods toward achieving more robust micro-SOC designs that leverage exploration and discoveries in improving micro-SOC structures of the related patent applications included herein by reference. There is accordingly discovered an advantageous combination of high-pressure capability with an unusually high effective electrolyte layer surface-area relative to prior art, and the surprising ability to implement an unusually high resistance to edge-separation-related failures at the micro-cell-level via specific means of tailored stress-relaxation structures that incorporate a more flexible surface aspect utilizing an annular inflection annulus structure, a specifically structured annular junction bearing-surface external to the inflection structure, and an asymptotic junction structure adjacent to that junction surface that is preferably also tailored toward and accommodating to a micrometer-scale adjustment of the precise junction location, where the free-standing solid electrolyte thin film of the preferred embodiments is asymptotically fastened to the bearing surface.

Another objective of the present micro-cell-structure embodiments is structural/compositional attributes wherein specific asymptotic interconnection structures and circular active electrolyte area provide a combined means for greater resistance to condensate formation and non-uniform condensate modification of electrode/electrolyte surface chemistry, as well as an overall relatively-higher capability to reduce failure modes attributed to the support alloy interface to the active electrolyte layer.

Another objective of the present invention in an alternative embodiment is structural/compositional attributes wherein current density is also rendered highly uniform by means of a centro-symmetric taper in electrolyte thickness relative to distance from a circular, metallic, relatively high-conductivity collection surface supporting the electrolyte at each circular micro-cell in a periodic array of micro-cells

Micro-Disk Conduction Paths: Robust and highly-durable attributes are also accomplished in unison with the above embodiments by rendering the above annular asymptotic junction structure as substantially isolated from the majority of micro-cell-level current-flow in the operating SOC device, by means of a controlled current pathway which simultaneously provides superior uniformity of both power density and any local heating of the annular junction. such controlled current paths have multiple advantages as is embodied further in sections regarding controlled voltage field gradients.

Alternative preferred embodiment of the present invention provides structural means for specifically confining the conduction path of the bottom-side of the free-standing electrolyte to the micro-disk, such that top-electrode primarily is disposed so as to primarily transfer current flow through the peripheral region of each electrolyte micro-cell, whereas the bottom-electrode is disposed so as to primarily transfer current flow through the central region and adjoining micro-disk of each electrolyte micro-cell. Whereas the transition layer is preferably a conductive material, in the present embodiment, it is preferred that it is not in electronic communication with the underlying alloy-based structure (17), and is instead substantially insulated from the underlying structure by way of a preferred insulation pedestal cap layer (233).

In addition to providing a structural “quasi-space-frame” aspect enabling greater durability and strength to the SOC cell, another objective of these micro-cell architectures is the specific control of electrode currents, which are largely resulting from ion conduction through the electrolyte, flowing across the micro-cell's freestanding composite electrolyte/electrode e layers, such that they are flowing across the electrode and counter-electrode in either a net-convergent or net-divergent direction with regard to the electrolytes central axis of circular symmetry. In this manner, voltage gradients of the device are found to be formed in a substantially greater level of uniformity, such that large, non-transient, localized voltage gradients that exist at specific structural locations/features across the micro-cell electrodes can be greatly reduced.

A related advantage of these structural embodiments of the present invention is that electronic conduction of the device is substantially isolated and displaced from the intersection of any conducting layer on the bottom-side of the free-standing electrolyte with the peripheral mechanical junction structure, such that a conductive transition layer of the junction is prevented from transferring any substantial current through the inventive asymptotic annular junction that joins the free-standing electrolyte to the supporting grid structure of the electrode/electrolyte assembly.

Another objective of the present invention reduction of localize hot-spot generation through having a multi-tiered, annular contact construction having utilization of separately-oriented radial sections wherein roughly linear arrays of opposing gas-guiding ribs residing adjacent to the opposite sides of the electrolyte layer are oriented at intersecting angles, such that a periodic array of opposing-surface regions are formed on the opposite sides of the electrolyte layer; whereas, these separately oriented regions of the annular array provide a radially uniform current density that is advantageous toward removing current-derived hotspots that otherwise develop due to direct interfacing of manifold ribs to the porous electrodes of conventional SOC stacks. This results in reduction of localize hot-spot generation, via higher uniformity in micro-cell-to-micro-cell thermal uniformity wherein each micro-cell current is dispersed in an intermediate micro-grid array before being contacted in opposed and crossed rib-manifold-electrode structures of the opposing manifolds.

Center-Tube/Valve Assembly: Yet another objective of the present invention is low-energy-storage-manifold means that quickly and simultaneously remove and separate main manifold gas/vapor contents from communicative passageways to the conducting electrolyte, by way of a central mechanical valving assembly, while otherwise maintaining a high-conductance and thermally centrosymmetrically-uniform manifold, thereby allowing high-conductance/high-efficiency gas transport during operation while allowing operator to quickly remove available oxidizer and/or fuel from possible interaction with the stack catalyst/electrolyte interfaces during an elected shut-down operation.

Yet another objective of the present invention is means for real-time diagnostic and high-temperature valve separation of steam, condensate-prone-gas, and/or fuel by means of a valve assembly that is individually addressable to each cell in the stack, thereby allowing powerful, real-time, in-operation diagnostics that are not possible solely through electronically-addressable cells, since electronic signatures from each cell may be tested in conjunction with highly-resolved individual modulation or shut-off of an incoming/outgoing gas/vapor, such as its oxidizer or fuel supply.

Accordingly, another objective of the present invention is individual cell isolation both for automatic diagnostics of each individual cell in the stack, as well as cell-down-time or cell subtraction so as to substantially increase operation life-time of the stack, with early warning of any needed stack swap-out.

Yet another objective of the present invention is allowing fast swap-out of stacks with minimum steam or condensate purging requirements, plus individual throttling, idling at highly throttled stage and changing of gas with minimum plumbing, combined with individually and separately removable stack and center-manifold assemblies.

Yet another objective of the present invention is gas-chemistry modulation means by way of an in-stack, automated motion-controlled, throttling mechanism that enables a large array of operation modes and diagnostics enabled by well-controlled, at-cell-level, fast modulation of gases and in-cell gas chemistry. For example, highly distinct and separate diffusion rates for different gases (e.g., steam vs H2) can allow effective modulation of in-cell gas compositions as a function of modulation speed of steam injection. Similarly, coking attributes and carbon deposition on carbon-rich input gases (CO2, a hydrocarbon, etc) can be modified by modulating the pressure and or composition of the gas, particularly with regard to H2 and OH-related partial pressures. Numerous other such schemes are contemplated.

Inert-Gas Shielding And Testing Assembly: Another objective of the present invention is to implement, for high-temperature/operating-temperature H2-sealing interfaces, an inert-gas shielding scheme that both protects via inert gas-shielding as well as allows real-time monitoring of all seals and their health, providing a monitor-able separation of the SOC stack from ambient gases/vapors of the surroundings via closed-loop inert-gas shielding.

Accordingly, an objective of the present invention is to provide multiple, dedicated inert gas streams that are hermetically sealed from other gaseous flow streams of the stack, wherein variable and modulated flow patterns of the inert gas, as well as real-time compositional monitoring of the inert gas flow allows operators of the stacks to immediately be aware of any seal failure as well as isolation of the seal-failure location. Such monitoring includes monitoring the inert gas flow for modification of percentage of gases and/or desorbed species in the stack including such gases common to SOC operation as H2, H2O, O2, CO, CO2, any hydrocarbon gas (such as methane/ethane/butane), or various other gases that include sulfur, phosphorus, iodine, chlorine etc. In some cases, a high-mobility gas such as helium is utilized as a tracer molecule in various passageways of the stack to monitor early signs of leakage; or, alternatively, in larger helium quantities for efficient thermal transfer of heat to or from the stack.

Another advantage of the present invention in its embodiments of N2 shielding/diagnostic passageways is by performing a second function of allowing controlled and accelerated fast-ramping of the low-mass/high-surface-area stacks wherein incorporated electrode compositions are disposed so as to be compatible with fast temperature ramping, this fast temperature ramping particularly executed within what are thereby, by virtue of the speed of ramping, metastable temperature regions of a persistent phase within the electrode materials matrix (e.g., Ni—Pt solid solutions), whereas this temperature region would otherwise comprise a phase transition region and accordant crystalline re-ordering in the known phase diagrams for these same material compositions (whether their phases be heterogeneous, homogenous, crystalline, or glassy) of the stack's electrode materials. The avoidance of the normally-attendant phase transitions in various electrode compositions, particularly Ni/Pt containing metallic phases allows avoidance of what is both structurally disruptive and destructive to the existing morphology of the electrode materials, as well as creating of accelerated volume changes that additionally create undesirable stress and potential fracture of the electrolyte layer. In assuring persistence of a single material phase and/or crystalline structure within various component phases of the electrode layers, a far broader array of intermetallic and solid-solution phases may be utilized in the various electrode layers with reproducible and higher performance; and, accordingly, the useful thermal cycling and lifetime of the SOC is extended.

Steam Thermal/Chemical/Electrical Uniformity: Another objective of the present invention in its steam electrolysis embodiments is to provide a centrally located supply and return steam path in an annular SOEC and preferably an annular tubular array such that downstream hydrogen created in the steam path of an annular cell is both relatively communicative thermally with steam upstream in a more outer annular region of the annular cell, and such that the downstream hydrogen is heated by converging toward the center of the annular cell, whereby the downstream hydrogen is heated by a supply-side steam that is diverging away from the center-tube module of the annular cell. In particular, it is preferred that the diverging supply-side steam is emitted into the annular cell by first passing a pressure-drop medium that decreases reverse flow and further increases the relative communication of hydrogen with the upstream steam in the annular cell, thereby increasing the radial uniformity of the annular cell via hydrogen transport within the annular cell. In this way, the outer regions of the annular cell are thermally equilibrated with the inner regions during the endothermic processes of the hydrogen electrolysis, wherein incoming steam is heating outgoing steam/hydrogen mixtures in a manner that provides thermalization by the relatively high-mobility hydrogen (in both upstream and downstream directions) that is trapped within the annular cell.

In certain conditions, such as when specific steam flows are desired that alter the thermal distribution, such controlled hydrogen thermalization can optionally be then further supplemented by utilization of heated or cooled inert gas streams recirculation within the inert gas passageways of the inventive SOC structures, wherein the more thermally-conductive helium can be readily introduced or removed from the nitrogen that is normally utilized.

Central Uniformly Radial Thermalization Scheme: Yet another objective of the present invention is annular, 3-tiered hierarchical array of gas-media manifold interconnecting passageway structures by way of a segmented radial pattern that maximizes uniformity of current density and rigid supports in periodic contact structures that are each highly anisotropic in radially separate sections that are distinctly-oriented in their anisotropic pattern.

Another objective of the present invention is to provide a highly radial-symmetry in flowing gas composition whereby an array of stack sub-manifold passageways all connected with circular symmetry to a larger central stack manifold thereby simultaneously each delivering a condensate-prone gas to an annular array of radially-oriented manifolds that are rotationally symmetric around a central axis, such that a density of sub-manifold passageways are each connected to a separately oriented cell manifold, such that a minimum of 6 six separate sub-manifolds per cell layer of the stack, and preferably more than 15 sub-manifold passageway circuits per cell layer.

The radial uniformity advantages as embodied specifically in a steam electrolysis SOC system are also understood to be applicable in the broader realm of SOC operating for SOEC and SOFC operation in general. Accordingly, the embodied centrally manifolded, uniformly radial thermalization scheme compensated by means of circumferential edge-heating and thermally-controlled inert gas traces allows an efficient, highly-monitorable, and uniform means of achieving controllable thermal uniformity in the stack, which allows high levels of control over temperature uniformity during dynamically changing operational conditions, particularly while simultaneously allowing more efficient gas separation due to the cell-level inlet throttling mechanisms combined with radially-uniform, well controlled, and high-conductance gas manifolding.

The radial temperature gradient can be additionally tailored via multiple now-readily implemented strategies, including but not limited to radially-grading any of the relative thickness of the electrolyte average thickness from center to periphery, radially-grading the ASR through compositional doping levels, radially-grading the gas-flow mechanics as provided by the features of the gas-flow manifold, as well as radially-grading the thermal sinking to the gas or solid elements from center to edge.

The above advantages of thermal and chemical uniformity are additionally combined with integral means of electrical uniformity by combination with the microstructure and layout of the individual cell layers and their areal array of micro-cells, wherein high levels of power density are achieved by greater distribution over a far greater density of cell layers, in combination with a “micro-cell” design at the microscopic level that further reduces hot-spot generation and non-uniform voltage gradients,

Cyclic-Potential And Gradient-Sweeping Capability: High-frequency modulation of stack/cell voltages from slow modulation up to high frequencies in the gigahertz range can be utilized with far greater advantages, power, controllability, and resolution in the present invention due to the circular symmetry of the SOC system in combination with its first preferred electrical contacting scheme, which is disposed symmetrically so as to provide advantages in maintaining the integrity and waveform of desired frequency/pulse shapes of an input signal that is both applied to and received from the stack.

The aforementioned circular symmetry and contact scheme is particularly advantageous in various SOC applications (both SOEC and SOFC) wherein it is utilized both for modulating the power transfer through the stack as well as in diagnostics and pin-pointing of any spatial variation in stack properties. Such control is significantly greater than in SOC stacks of the prior art in part through a circular phased-array of high-current-capacity electrical contacts.

Power modulation of stacks can be utilized to increase lifetime and thermal cycling capability of the stack by helping to maintain the integrity of the stack's compositions, material phases, and micro-structures. For example, modulated power is well-known to be useful in the selective electrodeposition or electro-etching of both conductor and non-conductor surfaces. The selectivity of such processes can be utilized to modulate adsorption and/or reaction onto the electrode interfaces so as to preferentially remove certain undesirable contaminants or impurities. Alternatively, such modulated power can either enable or frustrate the formation of various material phases or morphologies that can effect operation of the SOC system over time. Such selectivity is of great potential in inhibiting various corrosion and galvanic processes that can otherwise deteriorate stack performance.

In an alternative preferred embodiment of the preferred electrical interconnection and geometry, utilization of alternating power in conjunction with the unique conduction symmetry of the preferred SOC stack design is advantageous for providing more uniform heating via the application of phased circulating currents on the phased array of contact interconnections at each cell. Such phased array heating is particularly advantageous for avoiding hot-spot development that results from physical cascading and electromigration processes inherent to many forms of DC open-circuit failure.

As a result, for example, an intermittent pulsing of the potentials around the annular surface of the active region will more readily transfer to uniformly sweeping emf gradients uniformly across each of the pixilated (i.e., micro-cell) electrolyte surfaces of each cell, in a resolvable manner and bandwidth that are not possible with the standard square or oblong stacks, or in button cells, of the prior art. Particularly in (but not exclusive to) the HAFTA modes of the current invention's annular embodiments, excitation via electronic mobility in the three-phase-boundary (or a reformer) of the cell can thus be enhanced wherein critical catalysis and conversion processes take place. In this way, in such an annular geometry, momentary lateral gradients may be created so as to control or modulate migration of charged species or polarized molecules with useful uniformity across an electrode surface, rather than only through the capacitive (ohmic, inductive, etc.) interactions across the electrolyte layer orthogonal to the lamellar interfaces of the cell as in conventional impedance spectroscopy scenarios. In this way, not only can a range of activity barriers in the cell be explored, modified and lowered, but a new and useful area of diagnostic impedance spectroscopy can be explored and leveraged. Chirality and chirality-reversal of the polyphase signals applied to the annular cell, in addition to an inherently larger useful bandwidth and waveform-engineering potential for such ring-shaped geometries, may then be constructive toward developing a greater understanding and optimization of the molecular and electronic processes taking place in the microscopic interface-level of the cells. In some cases, individually-addressed and layered annular cells may result in various unique opportunities to introduce heterodyne processes, beat frequencies, pulse shaping, surface-acoustics, wave-combination and mixing, and other such manipulations of wave mechanics and resonant materials interactions. Also, unlike in thick-electrolyte SOC structures involving large flat thick electrolyte and electrode layers, these aforementioned approaches are also more distinctly useful, due to the more responsive nature of far-thinner diffusion pathways and insulators in the present large-area, thin-film-based, micro-SOC structure, wherein a relatively small but well-controlled, voltage gradient (or ripple) will be capable of registering a noticeable electrochemical interaction when implemented as, for example, a DC-biased oscillation (or alternatively a very short effective rotating/chiral pulse duration) during stack operation.

Voltage Potential gradients: Another advantage of the present invention in its mirrored HAFTA interconnect structure is to allow a low-cost and robust stack that allows highly controlled diagnostics and monitoring of individual cells during stack operation, particularly through implementation of parallel current collections rather than series conduction.

Impurity-Resistant Electrodes: Another primary objective of the invention when using non-HAFTA-exclusive embodiments is obviating galvanic ionic exchange with metallic bi-polar plates via architecture frustrating electro-migration using regular array of substantially lateral potentials resulting in lateral surface migration of charged species. Mixing through a net surface diffusion around the annular cell opens several options for frustration of localized chemical potentials in a manner that is distinct from the normal; diffusion pathways of a conventional SOC cell. Arresting residence time of ionic species can be useful in avoiding non-uniformity in the stack that may otherwise result in preferential formation of point defects that are, for example, due to local accumulative effects in the local environment of the cell (e.g. local static field strength) rather than a material defect of the interconnect. In some case, wherein a voltage “sweep” gradient flows around the cell's active area, concurrent microscopic and highly localized heating events incurred by the momentary field fluctuation may also be capable to prevent a condensation or similar particle-nucleating event.

The aforementioned means of quickly modulating cell temperature relates to another objective of the present invention, which is structural/compositional attributes whereby efficient, fast, and uniform cooling/heating means of the present invention provide means to mitigate degradation due to dwell-time in intermediate temperature regimes during heating colling cyldes. The migration of Ni is attenuated by way of maintaining Nickel-containing phases and solid-solutions in a single isomorphic state, so that decorated boundaries of Ni-containing phases are not disrupted due to the phase-changes that would otherwise occur during heat-up and cool-down cycles.

A preferred approach is utilizing thermal-shock-resistant stack constructions for the preventing of nickel hydroxide formation and migration by way of preserving surface morphologies, and thus minimizing available surface energy, via the quenching of promising metastable phases, thereby leveraging kinetic boundaries to thermal-cycling-induced phase transition and growth.

In the present invention, such metastable alloy morphologies of various intermetallics of Ni, Ru, Pt, Rh, Au, Ag can thus be held in an isomorphic state through many thermal cycles. For example a solid solution, such as one corresponding roughly to composition of Ni3Pt, can be quenched before transitioning during intermediate temperatures into its equilibrium room-temperature intermetallic phase, or transitioning into inhibited sub-micron grain-growth such that normally-observed bulk properties are avoided toward preserving the higher-temperature, solid-solution properties. Eutectic forming minor components and grain-decorating components may be utilized in such scenarios without compromising the relative inertness of these compositions in oxidizing environments. Such grain-growth inhibition techniques are advantageously used in particular by way of integration with IT-SOC large-area u-SOC embodiments operating below the effective activation energies of Ni-particle coarsening, wherein these methods are used alone or in combination to prevent undesired morphology changes, grain-coarsening, and other such micro-structural disruption that will result in a net increase of diffusion of nearby reactants to Ni fracture-surfaces within the Ni-electrode.

Both solid-solution equilibrium FCC phases and other phases, particularly metastable intermetallic phases, of Ni—Pt can be maintained stable through equilibrium transition loci of the Ni—Pt phase diagram by the relatively fast-thermal ramp processes through transformation temperature region, which are allowed via the high thermal-shock resistance of the inventive SOC construction. For example, by means of sub-micron layers of Ni3Pt or similar catalytic-alloy particle arrays on the embodied high-density surface area stack scheme, such common electrode structures as Ni:CeO2are maintained having stable, uncontaminated Ni metal inclusions, particularly due to the both the higher distribution of current flow over a larger areal surface area (not simply integrating porosity-defined surface area), as well as due to the ability to ramp thermally at an accelerated rate (faster than 10.0Kelvin/minute) so that quenching of high-temperature, metastable morphologies are possible. The combination of higher areal surface area and fast quenching are applicable to maintaining metastable phases to enhance electrode durability across many similar scenarios.

In addition, metallic grains, precipitates, and/or inclusions can maintain their interface integrity in their interface to an oxide-based phase (e.g., ZrO2, CeO2, Ce2O3, cerium gadolinium oxide, etc) due to the ability to quench these interfaces through temperature regimes wherein either/both of the interfacing phases can otherwise be prone to re-coordinate into a different material phase or a different valence state (e.g. a CeO2-based valence transformed to a Ce2O3-based valence). In this way, a desired morphology of a constructed electrolyte/electrode structure can be maintained in a manner that is consistent both with the room-temperature metastable condition in a quenched state, or in the stable condition of the operating temperature, whereas dwell-time in any intermediate transition temperatures experienced by the inventive SOC device is insufficient for enacting a phase or molecular-coordination transition. The combination of thermal-shock-resistance of the inventive SOC stack architecture, combined with uniform rapid temperature ramping/cooling, is also particularly advantageous as a means for maintaining phase-stability of ferritic steels of the preferred embodiments (e.g, 430ss) from experiencing significant dwell-times in an unstable temperature regime. For purposes of an exemplary embodiment only, in one preferred embodiment utilizing SUS430 ferritic steel, the dwell time of the SOC stack is modulated for operation between 500 C for purge/cleaning purposes, to 650 C for efficient electrolysis operation. Through the inventive inert-gas purging means embodied herein, the intermediate temperatures between 500 C and 600 C, are largely avoided by means of controlled uniform ramping/cooling plus stabilization in less-than 30 minutes and preferably, less-than 10 minutes, even for larger (e.g., >500 cm2 area) cell sizes and stack sizes. This rapid thermal equilibrium capability is further enabled by the low mass-specific density per unit area of the inventive cell structure, which may be determined as unusually low by the thicknesses and materials cited.

Micro-Compliant And Self-Aligning: Another objective of the present invention in its self-aligning embodiments is a micro-compliant mechanism and alignment structure that is formed into rolled steel alloys through micro-polish methods of the electro-polishing and/or plasma-electro-polishing (PEP) arts.

Another objective of the present invention in its self-aligning embodiments is a micro-compliant hexagonal mechanism and alignment structure that provides its functionality as integrated within a plurality of high-aspect-ratio dish-shaped electrolytes.

Another advantage of the present invention in its self-aligning micro-compliant embodiments is self-aligning pedestal interfaces preferably through a V-groove mechanism that promote highly uniform electrical contacting while also improving both gas compositional uniformity and flow.

Another advantage of the present invention in its self-aligning micro-compliant embodiments is self-aligning pedestal interfaces preferably comprising an inter-locking mechanisms that allow reliable assembly and registration of electrical contact surfaces.

The various embodiments set forth herein are also very-well suited for LT-SOC operation; particularly, proton conduction through hydroxide-enabled transport and other mechanisms as realized through such solid-oxide electrolytes as the apatites and various dopant/substituted forms of barium zirconate. Those skilled in the art will appreciate that the objectives and advantages of various embodiments described herein are useful and applicable to a broad array of virtually SOC-based energy conversion apparatus, including both the SOEC and SOFC applications, low-temperature-SOC (LT-SOC), intermediate-temperature-SOC (IT-SOC), and the more conventional high-temperature SOC systems, any of which may be reversible between fuel cell mode and electrolyzer mode. In addition, the various embodiments are particularly useful for the micro-SOC stacks particularly pointed out herein.

For intermediate temperature (600-700 Celsius) and low-temperature solid-oxide cells/stacks, the apatites, such as lanthanum-silicate-based compounds, are seen to benefit greatly from the architectures embodied herein. With regard to LT-SOC andIT-SOC, another advantage of the present invention is to allow utilization of proton-conducting solid-oxides in a configuration that improves reliability of such materials. Such proton-conducting solid oxides are exemplified by rare-earth-doped barium zirconium oxides, or the various substituted apatite-oxide phases that are well-known in the art as fast ion-conductors for proton conduction.

In such proton-conducting embodiments of the inventive SOC, degradation is reduced of these materials via a combination of reducing the physical stress-strain-induced diffusion of hydroxide molecules within the oxide electrolyte via the corrugated, free-standing nature of the inventive SOC, in combination with maintaining lower current density per cell, whereas overall electrolysis per-unit-volume is maintained by way of the high cell density (greater than 30 cells per inch of stack depth).

In addition, rare-earth-doped (“RE:”) Barium-magnesium-zirconium-oxide are specifically preferred, particularly of nominal composition RE:BaₓMg_{y}Zr_{z}O2 wherein, preferably, y<x<2y, are preferably utilized, wherein the magnesium hydroxide bonding of the electrolyte enables higher stability during ion conduction.

Due to the physical and thermo-mechanical resilience of the structures disclosed herein, the disclosed embodiments are particularly well-suited to proton conducting solid-oxide electrolytes such as exemplified by the yttrium-barium-zirconate electrolyte compositions that are highly reported in the prior art as promising solid-oxide, proton-conducting electrolytes.

In particular, oxygen conductors, proton conductors, and mixed conductors combining functions of both proton and oxygen conduction are seen as particularly preferred in conjunction with magnesium barium zirconate compositions.

Barrier Encapsulation layers: Whereas the barrier embodiments for the alloy-based grid-array structures of the present invention are such that all such thin-sheet alloy structures will be incorporating an enscapsulating barrier structure and composition roughly in accordance with previous patent applications by same author and included herein by reference, there are also improvements to these barrier structures that have been developed and are also embodied in a separate embodiment herein.

In particular it is preferred that the pedestal cap layer (233) comprise a heavily Mg-doped Zr that incorporates sufficient Mg doping so as to include mixed phases of Mg-doped and magnesium zirconate coordination. In on preferred IT-SOC embodiment the electrolyte is also containing a Mg-doped ZrO2 as a fast O2 conductor. Certain LT-SOC embodiments may utilize a similar pedestal capping layer composition as above, with a BaMgZrO mixture that provides substantial proton conducting attributes.

Definitions: for purposes of the present patent application and disclosure, the following terms shall be defined as follows:
“SOEC” shall refer herein to Solid-Oxide electrolyte-based systems that utilize at least one solid-oxide cell for producing a chemical-energy-containing substance through consumption of energy, which is typically a combination of electrical and/or thermal energy.
“SOFC” shall refer herein to Solid-Oxide electrolyte-based systems that utilize at least one solid-oxide cell for producing electrical and/or thermal energy.
“SOC” shall refer herein to the group of devices that incorporate at least one Solid-Oxide Cell, whether that cell is utilized for the functions of a SOFC, a SOEC, or both.
“SOES” shall refer herein to Solid-Oxide Electrolyte Systems wherein this will be any integrated system incorporating a SOFC or SOEC.
“stack” shall refer herein to an assembly of multiple cells, whether the cells may be operated electrically in series or parallel connection.
“cell” shall refer herein to a electrolyte-based device that comprises an electrolyte for performing electrolysis, fuel-cell-type power generation, or a reversible operation between electrolysis and fuel-cell mode. The term “cell” used herein without qualifier will therefore refer to one cell that can optionally comprise one cell of a SOC stack.
“flat-tube-SOC” shall refer herein to a specific type of tubular SOC that utilizes an electrolyte geometry that comprises a physical passageway having roughly a parallel-planar aspect (regardless as to any topography/features of the roughly-planar aspects; e.g., corrugated) that is accordingly forming a roughly parallel-planar cavity such that the opposing inner surfaces defining the cavity are (as with conventional tubular SOC) both providing a similar electrolyte/electrode function and polarity consistent with a gaseous/vapor species being passed through the passageway and contacting the opposing inner surfaces.
“planar SOC” shall refer herein to SOC that incorporate planar-parallel cells and typically bipolar interconnect or dividing structures, consistent with prior art definitions.
“r-SOC” shall refer herein to reversible-SOC in its most broad definition within the relevant reversible-SOC art.
“μ-SOC (or “micro-SOC”) shall refer herein to SOC structures that incorporate electrolyte layers that are thinner than that commercially achievable through cast/calendar methods of conventional ceramic processing; and, whereas there are conflicting definitions in the prior art, will herein refer to SOC-based devices wherein the electrolyte layers is less than 50 micrometers. The large-area μ-SOC of the present invention are accordingly not limited in areal dimensions or output power, since the inventive μ-SOC embodiments of the present invention (as differentiated from the “micro-cell”) comprise the embodied dense, periodic grid-array of “micro-cell” structures that are embodied) may be formed over large area flexible or rigid sheets similar to other microstructures of the thin film arts as is common in flexible electronics, architectural-glass, and elsewhere.
“thin-film micro-SOC” shall refer herein to SOC having the electrolyte layers is less than 10 micrometers.
“LT-SOC” shall refer herein to Low-Temperature-SOC, which are SOC that provide useful function of an SOC in a temperature range below 650 C.
“IT-SOC” shall refer herein to SOC shall refer herein to Intermediate-Temperature-SOC, which are SOC that provide useful function of an SOC in a temperature range between 651C-750 C.
“HT-SOC” shall refer herein to High-Temperature-SOC, which are SOC that provide useful function of an SOC in a temperature range above 750 C.
“HAFTA” shall refer herein to Hybrid Annular Flat-Tube Array, a SOC geometry and construction that is a hybrid between tubular-SOC and planar-SOC operationally, such that the conditions normally attributed to both tubular-SOC and planar-SOC, as defined herein in the preferred embodiments. It will be understood that such HAFTA-type SOC constructions are capable and applicable to any of the SOC operational modes and electrolyte types referred to herein.
“chemically-active” shall refer herein to a property that is active in performing a chemically-related function that is useful in an SOC's functioning, whether that of catalysis, ion conduction, surface transport, chemisorption, physisorption, reaction, dissociation, desorption etc.
“centipede” contact array” shall refer herein to a micro-cell-scale contact topology/feature array that comprises a plurality of roughly identical contact surfaces.
“Annular-flat-tube” shall refer herein to a an annular structure forming an annulus having an inner diameter and an outer diameter such that the annular structure is defining a passage-way disposed to provide a net transport of a gas/vapor there-through, the passageway disposed such that the overall passage of gas is able to flow in a net radial direction including either a radially outward direction or a net radially inward direction with respect to the annulus' central axis of symmetry.
“asymptotic” shall herein refer figuratively to structures wherein, in an aspect, embodied surfaces come into contact with an asymptotic-like appearance in that there is a spatially-gradual decrease of spacing between the two surfaces being described herein as “asymptotic.” No conformance in any way to a mathematically rigorous meaning or requirement is implied in this usage.
“micro-compliant” shall refer herein to a mechanical characteristic whereby a precisely-defined structure with precisely-defined features nonetheless possesses a very-limited degree of mechanical flexibility, typically on the order of micrometer-scale distances of mechanical compliance/flexure, along a selected figurative axis of the structure.
“highly centrosymmetric, centrosymmetric” shall refer herein to degrees of rotational and circular symmetry of components and features herein.
“micro-cell” shall refer herein to the individual, non-planar electrolyte/electrode structures and features that are disposed within and immediately adjacent each of the individual through-hole cavities (19), which are formed preferably as hexagonal periodic grid-array of such through-holes in a preferably barrier-encapsulated metallic alloy foil, as disclosed at length in the related patent disclosures regarding SOFC and SOEC devices by same author. Accordingly, terms hyphenated by “micro” such as micro-cell, micro-dish, micro-cell-element, shall refer to the structures of these individual micro-like structures and articulated features, compositions, and the control/behavior of such individual micro-like, or micro-cell-type, structures.
“electrolyte effective surface area” shall refer herein to an effective continuous surface area defined by that mid-layer surface of the solid electrolyte layer that divides the half-cell reactions on the opposing sides of the electrolyte layers in an SOC; and, accordingly, which is orthogonal to the mean direction of ion transport (e.g., oxygen or hydrogen ions) at any point within the electrolyte (directionally independent of irregularities due only to surface roughness).
“foil”: the term “foil” in the present invention shall refer to preferably rolled-metal and flexible sheet material that is having a thickness of equal to or less than 10 mil (or, roughly, equivalent to 254 micrometers). Whereas “foils” of the present invention can be accordingly thicker than normal, and include foils, strip, sheet available commercially, the term is utilized herein to clarify that such foils are of a limited thickness that is readily patterned with via/through-hole features; and relatively light-weight and thin relative to SOC structures of the prior art, as well as of thinner aspect than most silicon wafers utilized in thin-film-based micro-SOC fabrication in the literature.
“layer”: a material layer referred to in the present invention is referred to as a “layer” in the broad sense of the existence of material phases that are compositionally and/or morphologically distinct from adjacent layers. Accordingly, and consistent with the prior art, such “layers” of the present invention may comprise highly porous, heterogeneous, or otherwise discontinuous materials that are found in the prior art of catalytic and electrolytic layers. The pointing out of layers in the drawings of the present invention is therefore not intended to be limiting to the nature of the layers or the nature of the layer boundaries, which may be abrupt, diffuse, irregular, or discontinuous in ways that are common in the prior art of electrodes, catalysts, and electrolytes, and related material layers of the prior art. For example, a “composite electrode/electrolyte layer” is understood to be a layer that itself includes multiple layers consistent with the electrode structures, graded electrolytes, transition layers, etc., that are included in such embodiments. Each cell “layer” of a layered SOC stack will accordingly include the embodied diffusion barriers, insulator layers, contactor layers, foil layers that have been embodied as integral to each cell “layer”, wherein each single cell is separately embodied as an integrated, highly lamellar structure on its own.
CPG—Condensate-Prone Gas: a gas-phase gas/vapor composed of chemical substances that are prone to forming condensed material onto or into solid structures of a SOC-type device, in any condensed form (liquid, solid, nano-structured, surface-reacted, chemisorbed, physisorbed, etc). Accordingly, a CPG is comprising such gas compositions on either an anode-side or cathode-side of a SOC-type device that can result in wet-steam characteristics that deposit condensed water molecules, or carbon and carbon-compounds, or sulfur and sulfur-compounds, or hydroxides, and/or any other such chemical substances that once deposited onto the surfaces of the SOC device, can substantially modify the operational characteristics, degradation processes, and other such effects that modify the SOC performance. Accordingly, steam, CO2, CO, hydrocarbon gases, sulfur-containing gases, all of which are known to form condensates in SOC devices, are for example included herein as a CPG.

Other objects, advantages and novel features of the invention will become apparent from the following description thereof.

### BRIEF DESCRIPTION OF THE DRAWINGS

FIG. 1 is an embodiment of alloy-grid-support structure of an SOC by same author in previous disclosures.

FIG. 2 is an embodiment of alloy-grid-support structures and SOC fabrication method/structure by same author in previous disclosures.

FIG. 3(a) is a sectional side-view of an SOC stack assembly in accordance with a preferred embodiment; and, FIG. 3(b) is a separate sectional side-view of the identical SOC stack assembly in accordance with a preferred embodiment.

FIG. 4(a) is a side-sectional view of an electrode/electrolyte assembly included in previous patent by same author; FIG. 4(b) is a diagram-type, close-up, partial side-sectional view of an individual micro-cell edge area with preferred dimensional relationships included in previous patent disclosure by same author; FIG. 4(c) is a diagram of spatial relationships in a close-up side-sectional view of an individual micro-cell dimensions in accordance with the preferred embodiments; and, FIG. 4(d) is a diagram-type, highly magnified close-up, side-sectional view of the individual micro-cell in accordance with enabling improvements of the preferred embodiments.

FIG. 5(a) is a diagram-type, close-up, top-view of an individual micro-cell dimensions in accordance with previous embodiments by same author; and, FIG. 5(c) is a diagram-type, close-up top-view of an individual micro-cell dimensions in accordance with enabling improvements of the preferred embodiments.

FIG. 6(a) is a diagram of the, close-up, side-sectional view of one side of an individual micro-cell edge area with preferred dimensional relationships; FIG. 6(b) is a set of three numbered diagrams number (i), (ii), and (iii), corresponding to a side-sectional partial view of an individual micro-cell edge-junction; and, FIG. 6(c) is a, side-sectional partial view of an individual micro-cell edge-junction in a magnified close-up view.

FIG. 7(a) is a is a side-section view of a tubular SOC utilizing a distributed radial tube array; and, FIG. 7(b) is a is a top-view of the tubular SOC utilizing a distributed radial tube array; and, FIG. 7(c) is an idealized “dendrite-type” embodiment of the tubular SOC utilizing a distributed radial tube array.

FIG. 8(a) is a manifold structure in a hybrid annular flat-tube array in a preferred embodiment of the invention; FIG. 8(b) is a hybrid annular flat-tube array; FIG. 8(c) is a top-view of a hybrid annular flat-tube section of a HAFTA module; and, FIG. 8(d) is a side-section view diagram of the active region in a preferred embodiment utilizing mirrored quasi-space-frame structures.

FIG. 9(a) is a side view of a sealed HAFTA cell module in accordance with a preferred embodiment; and, FIG. 9(b) is a partial side-section view of a radial array of HAFTA modules in accordance with a preferred embodiment.

FIG. 10(a) is a side-section view of a SOC stack assembly in accordance with preferred HAFTA embodiments of the present invention.

FIG. 11(a) is a magnified side-section view of a SOC stack in accordance with preferred HAFTA embodiments of the present invention, wherein magnified side-section view is the closed-caption box (10) in FIG. 4(a); and, FIG. 11(b) is a side-section view of a portion of a separated HAFTA cell including a sealed HAFTA module and associated HAFTA module separator comprising an oxidizer manifold assembly of the preferred embodiments.

FIG. 12(a) is a semi-transparent top-view of a SOC stack of the preferred “90-degree-rib-scheme” embodiments, wherein opposing manifolds of each cell of the stack are comprising manifold support-ridges that are intersecting at a 90-degree relative orientation; and, FIG. 12(b) is a semi-transparent top-view of a SOC stack of alternative preferred “hexagonal-rib-scheme” embodiments, wherein opposing manifolds of each cell of the stack are comprising manifold support ridges that are intersecting at a 60-degree relative orientation.

FIG. 13(a) is a top-view of an annular, monopolar, mirrored manifold utilized as a HAFTA manifold of the preferred, “90-degree-rib-scheme”, embodiments; FIG. 13(b) is a perspective view of the same annular manifold; and, FIG. 13 (c) is a side-sectional view of a staggered-aperture structure dividing sections of the manifold's annular ribbed-distribution region.

FIG. 14(a) is a close-caption perspective view of the close-caption box 10a in FIG. 13(b); and, FIG. 14(b) is a more highly-magnified close-caption perspective view of the close-caption box 10b in FIG. 14(a).

FIG. 15(a) is a top-view of an annular, monopolar, mirrored, O2-manifold in accordance with a preferred “90-degree-rib-scheme” embodiment; FIG. 15(c) is a perspective magnified closed-caption of the O2-manifold showing through-hole pattern; and, FIG. 15(b) is a top-view magnified closed-caption of the O2-manifold.

FIG. 16(a) is a top-view of an annular HAFTA-cover/separator-foil structure in one preferred embodiment.

FIG. 17(a) is a top-plan-view of an annular insert-form foil structure in a preferred embodiment; and, FIG. 17(b) is a series of magnified close-caption top-views, wherein each close-caption box is a close-caption box 10 of FIG. 17(a) in accordance with a separate preferred embodiment of the invention, which are each embodied in the shape of the general insert-form.

FIG. 18(a) is a top plan-view of micro-cell overlay structure for match to a reinforcing contactor foil; and, FIG. 18(b) is a top plan-view of a reinforcing contactor foil; FIG. 18(c) is a side sectional view of a micro-cell having substantially unidirectional current flow directions in conjunction with the preferred embodiments of the reinforced micro-cell.

FIG. 19(a) is a side view of a center-tube/valve assembly in accordance with a preferred embodiment; and, FIG. 19(b) is a side-sectional view with section taken through center axis (57) of the center-tube/valve assembly in accordance with a preferred embodiment

FIG. 20(a) is a side-section view of a top portion of a center-tube/valve assembly in a preferred embodiment, wherein the inventive valve assembly is in an “open” arrangement; FIG. 20(b) is a side-section view of a top portion of the center-tube/valve assembly in a preferred embodiment, wherein the inventive valve assembly is in an “shut” arrangement; and, FIG. 20(c) is a side-section view of a top portion of the center-tube/valve assembly in a preferred embodiment, wherein the inventive valve assembly is in an “diagnostics” cell-testing arrangement.

FIG. 21(a) is a perspective view of a center-tube module in a preferred embodiment; and, FIG. 21(b) is a side-section view of a top stack-interface portion (387) of a center-tube/valve assembly in a preferred embodiment, wherein the inventive valve assembly is incorporating porous throttling-inserts.

FIG. 22(a-c) are sectioned top-views of a top portion of a center-tube/valve assembly taken through horizontal plane (410) in FIG. 20(a), in three separate embodiments of SOC angular-pitch, wherein the inventive valve assembly is in an “open” arrangement; FIG. 22(a) comprises 24-degree angular spacing of ports; FIG. 22(b) comprises 20-degree port-spacing; and, FIG. 22(c) comprises 30-degree port-spacing.

FIG. 23(a) is a side-section view of a SOC-type cell incorporating a micro-compliant assembly in accordance with an alternative preferred embodiment; and, FIG. 23(b) is a magnified side-section view of a micro-compliant assembly in a preferred embodiment.

FIG. 24(a) is a closed caption, diagrammatic, top plan-view of a micro-compliant assembly in a preferred embodiment, in similar scale to that of FIG. 1(a); and, FIG. 24(b) is a closed caption, diagrammatic, top plan-view of a micro-compliant assembly in an alternative preferred embodiment.

FIG. 25(a) is a sectional top-view of a micro-compliant contactor-foil of the preferred embodiments; FIG. 25(b) is a top-view of the micro-compliant contactor-foil; and, FIG. 25(c) is a magnified top-view of the micro-compliant contactor-foil.

FIG. 26(a) is a top-view of a condensate-prone gas (CPG) manifold in the disclosed hexagonal manifold configuration of a preferred radially-contacted embodiment incorporating integral radial CPG-side electrical-contact tabs (427); FIG. 26(b) is a top-view of a non-condensate-prone gas (non-CPG) manifold of a preferred embodiment incorporating integral radial, non-CPG-side electrical-contact tabs (428); and, FIG. 26(c) is a top-view of a paired configuration of the CPG/non-CPG manifolds of these radially-contacted embodiments aligned by alignment plane (410) in FIG. 26.

FIG. 27(a) is a top-view of the inventive SOC stack assembly incorporating the radially-contacted embodiment incorporating integral radial electrical-contact tabs of FIG. 26.

FIG. 28(a) is a side-section view of inner seal area of the inventive SOC stack near its sealing plane (385) with the jacketed gas-passageways of the lower center-tube module, in FIGS. 28(a), as close-captioned earlier in FIG. 3(b); and, FIG. 28(b) is a side-section view of an alternative, non-HAFTA embodiment utilizing reinforcing foil in a non-mirrored SOC-stack embodiment wherein annular bipolar manifolds are separating cells of a series-connected SOC-stack;.

FIG. 29(a) is a magnified side-section view of an alternative embodiment comprising an ultra-high density (UHD) SOC-stack in an alternative embodiment having the HAFTA-type configuration, utilizing symmetrically-mirrored electrolyte/electrode structures; and, FIG. 29(b) is a side-section view of a SOC-stack in this alternative UHD embodiment.

FIG. 30(a) is an SOC stack/valve assembly in accordance with a preferred embodiment; and, FIG. 30(b) is an assembled series of the SOC stack/valve assemblies in accordance with a preferred embodiment.

### DESCRIPTION OF THE PREFERRED EMBODIMENTS

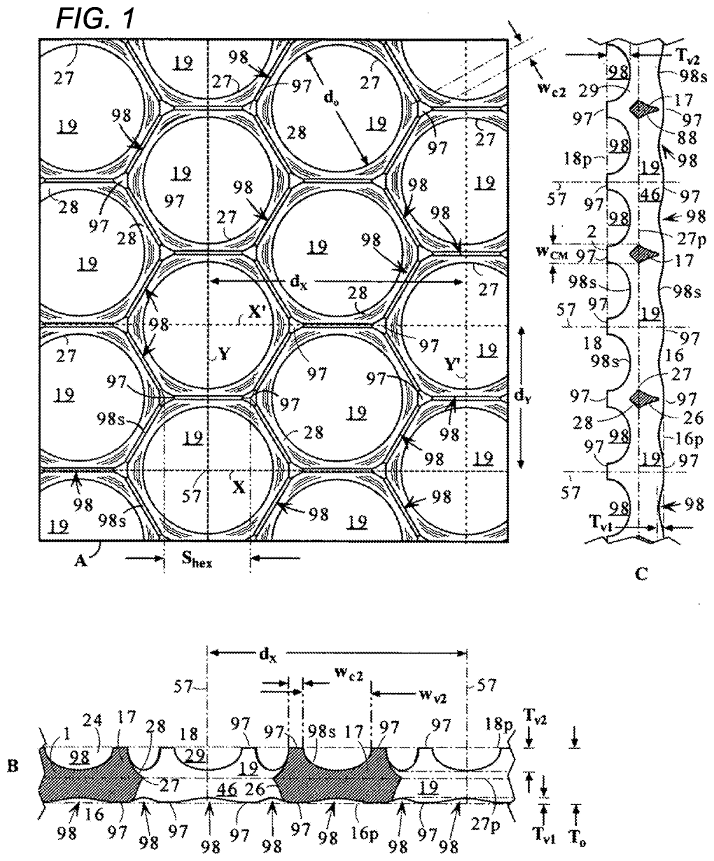

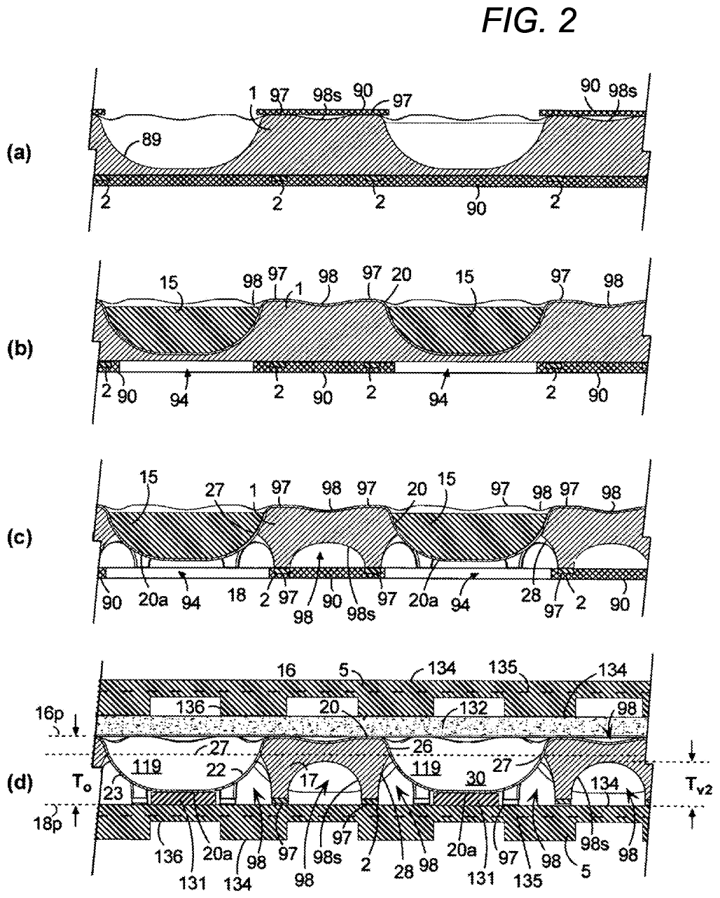

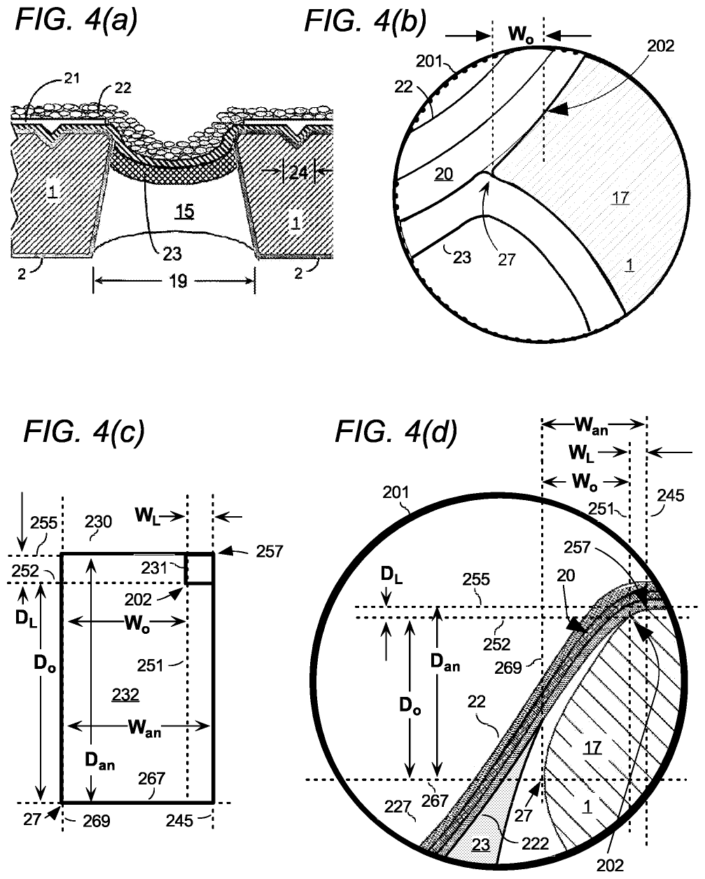

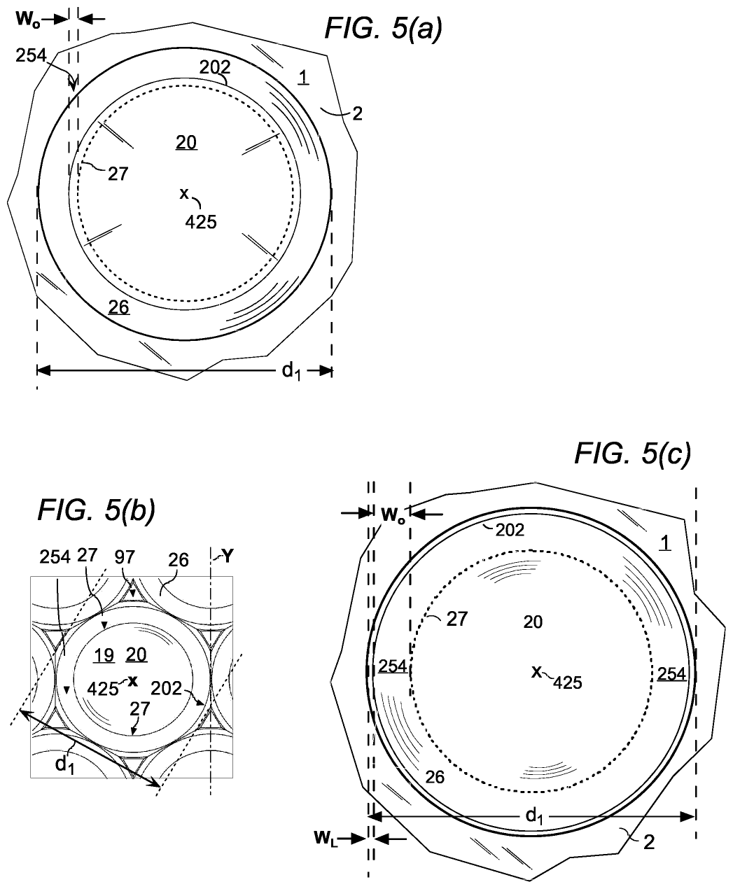

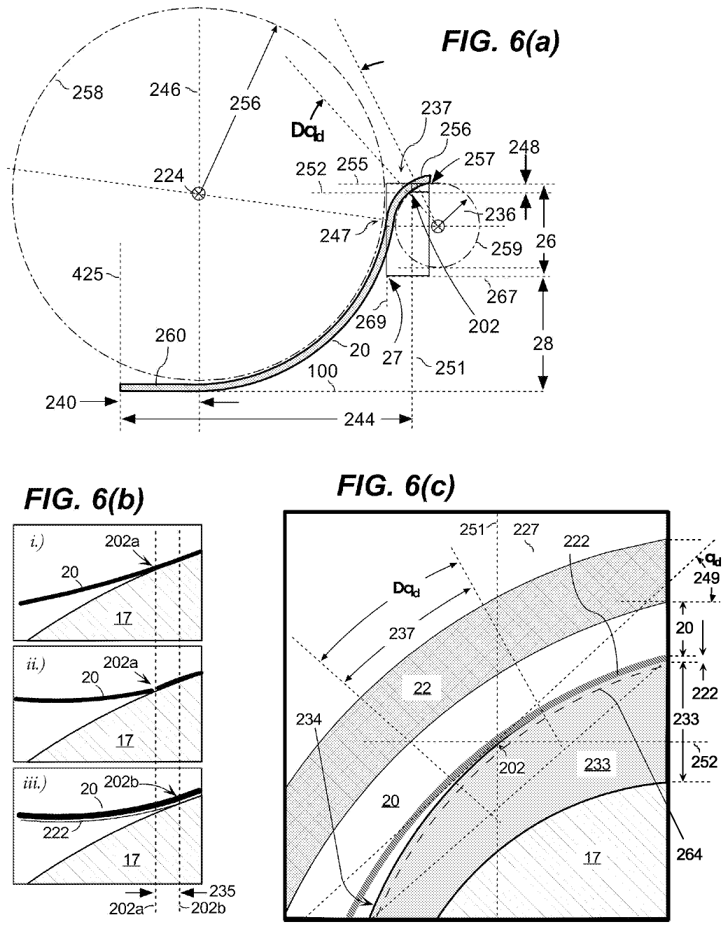

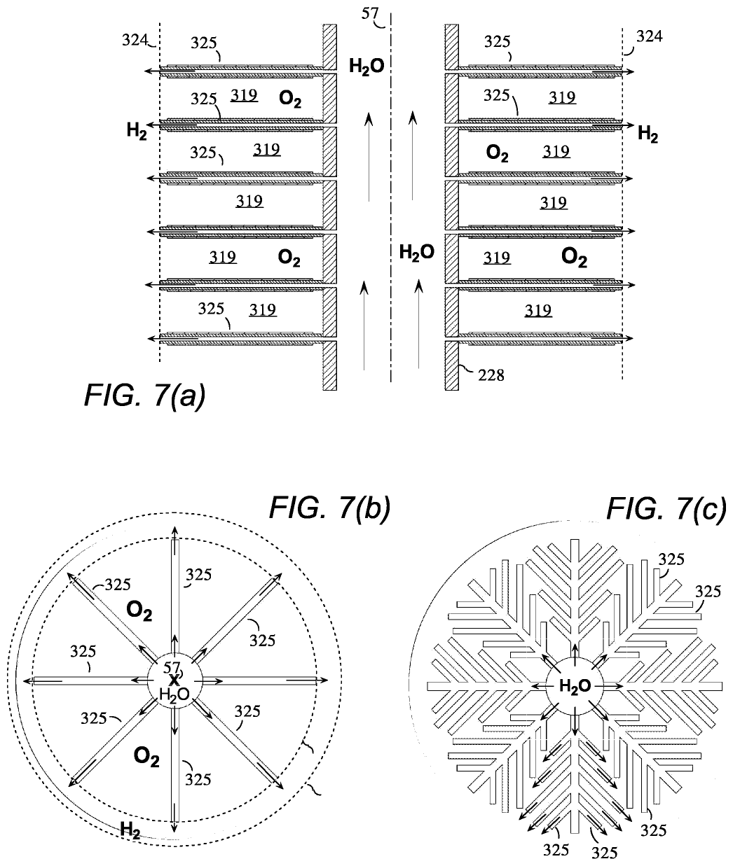

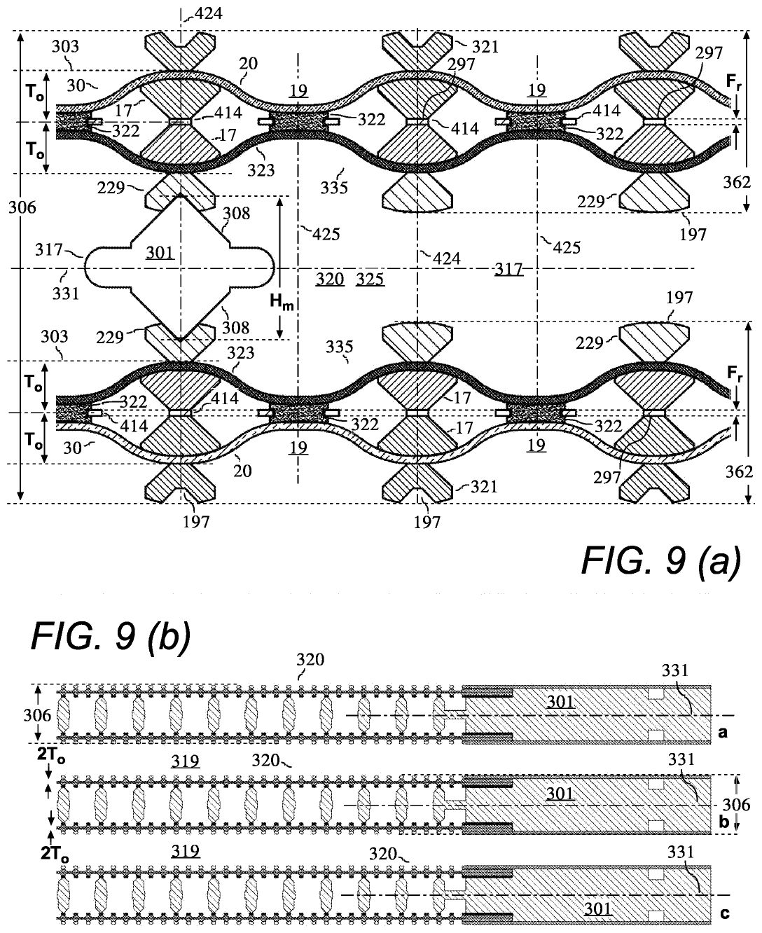

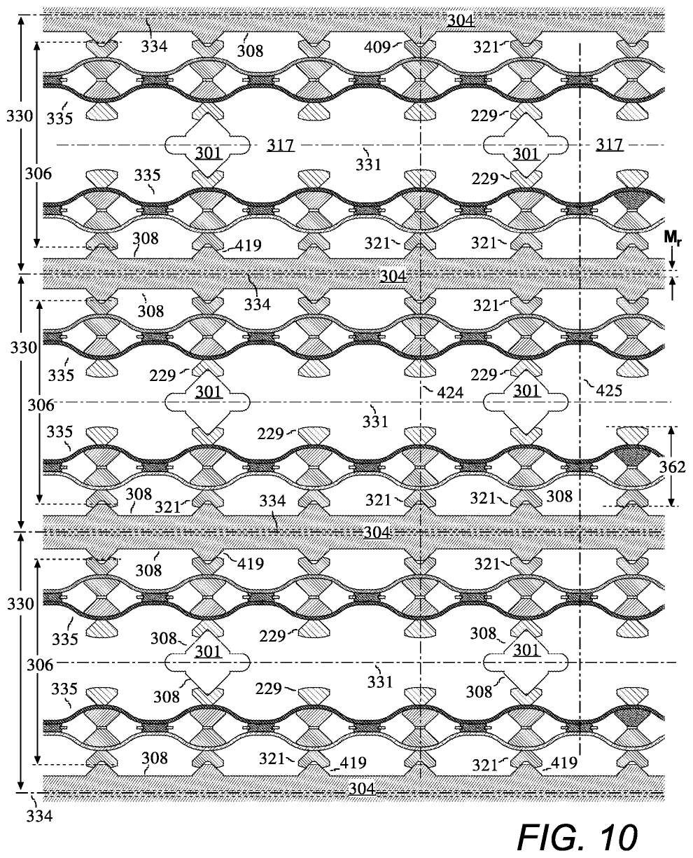

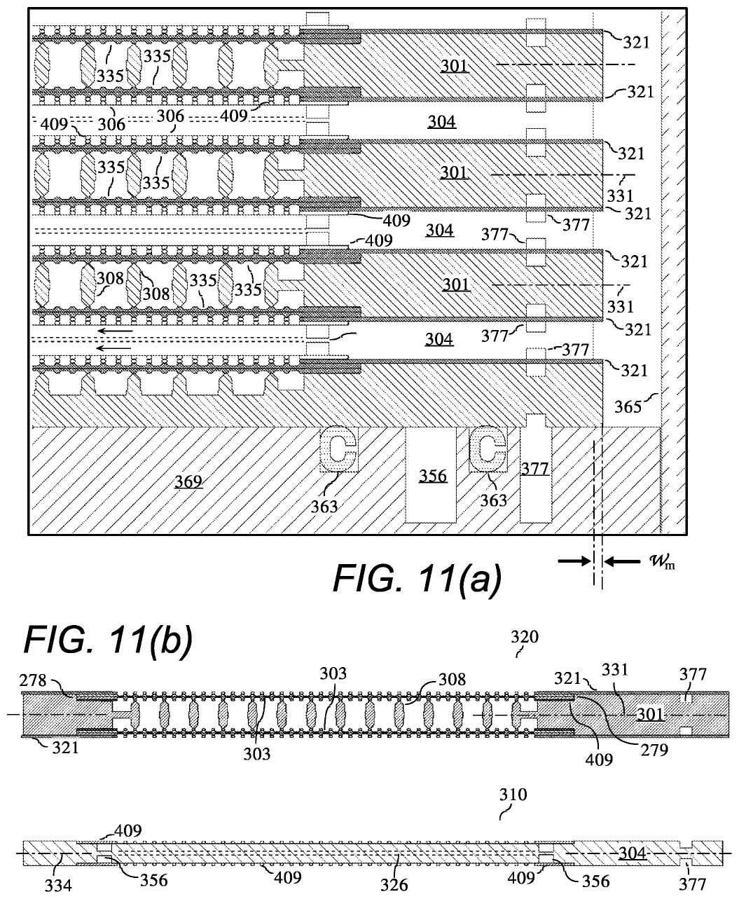

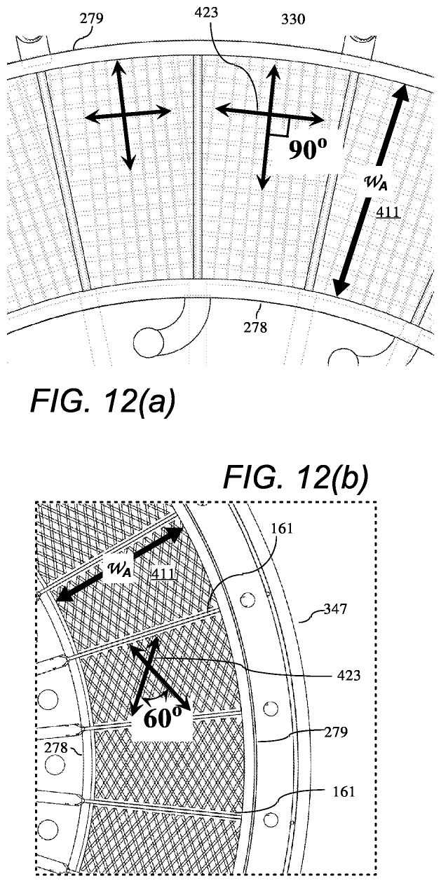

The following description and FIGS. 1-30 of the drawings depict various embodiments of the present invention. The embodiments set forth herein are provided to convey the scope of the invention to those skilled in the art. While the invention will be described in conjunction with the preferred embodiments, various alternative embodiments to the structures and methods illustrated herein may be employed without departing from the principles of the invention described herein. Description of preferred embodiments for FIGS. 1-12 are in related U.S. provisional patent application No. 63/618,336, filed Jan. 7, 2024, which is included herein by reference, in its entirety.

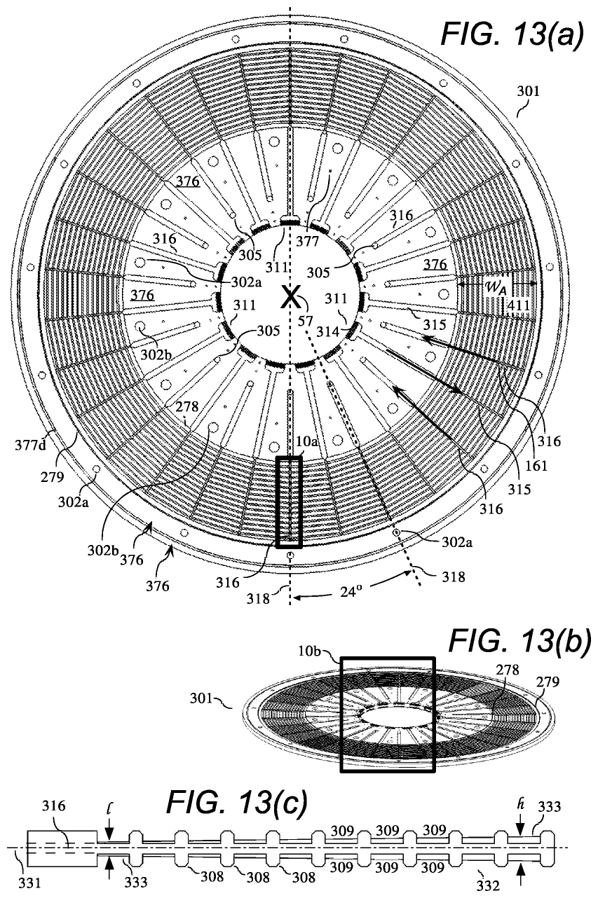

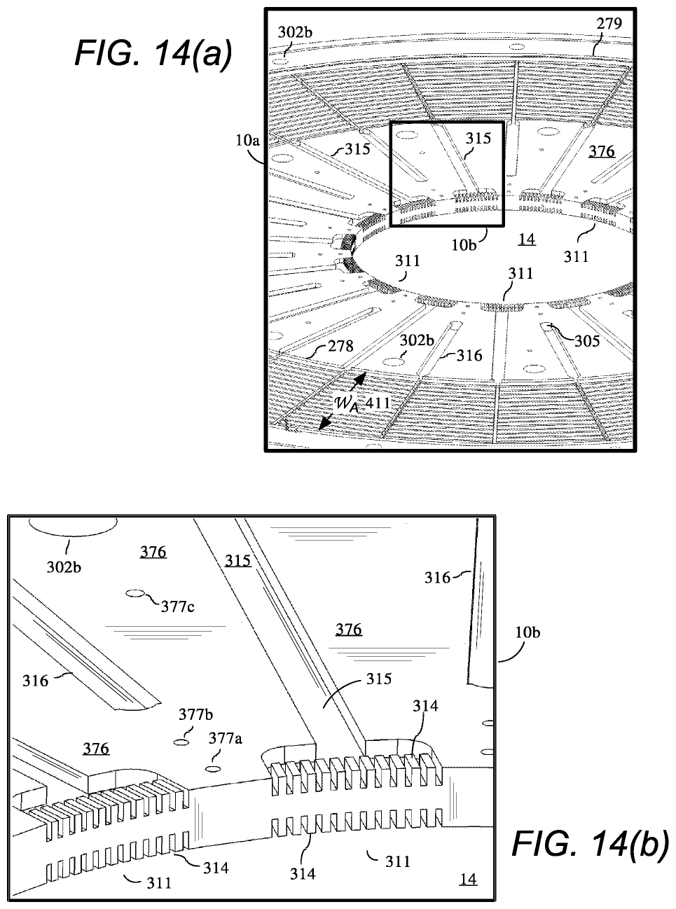

As previously discussed herein, in contrast to normal SOC construction, the first preferred embodiments of the present invention in accordance with their preferred HAFTA construction utilize a monopolar manifold structure (301) rather than a bipolar manifold separator that is disposed as the central structure of the HAFTA module, in FIG. 13-14, where this annular HAFTA manifold structure is more particularly pointed out in the present embodiments.

A preferred structural characteristic of the HAFTA manifold is that it provide monopolar and symmetric interaction with the mirrored electrolyte/electrode assemblies that are attached and interfacing to its opposing faces in the preferred HAFTA module, so that the interior HAFTA manifold (301) will have substantially identically-mirrored ridge arrays on either face with the mirrored active regions (411) and passageways formed into both of the opposing sides of this monopolar HAFTA manifold. A primary preferred attribute of the inventive HAFTA module assembly is that, when utilizing a condensate-prone gas (CPG) such as steam, or alternatively a carbon-creating gas such as CO2, a hydrocarbon, or alternatively a non-carbon hydrogen carrier such as ammonia, such gas is both introduced and extracted from the active regions of the stack through the center of the SOC stack assembly. Accordingly, CPG supply passageways (315) and return passageways (316) are formed into the inner portions of the annular HAFTA manifold, such that preferably the supply passageways will be fluidically communicative between the central volume of the center-tube module (371) and the active regions (411) of the HAFTA manifold, active regions herein referring to those regions directly interfacing to the annularly disposed active regions (11) of the electrolyte/electrode assembly in the previous patent disclosures by same author. In the preferred embodiments of the SOC stack assembly, it is also preferred that the CPG return passageways be communicatively attached to the jacketed return passageway for CPG flow that is located in the center-tube module. Accordingly, an interconnected and appropriately-sealed manifold passageway (305) in the HAFTA manifold provides passageway means for return of the CPG gas/vapor to the center-tube module.

Another preferred structural characteristic of the embodied HAFTA manifold is inner edge-wise apertures (314) that provide barrier-protected passageway of flowing gases into the sealed HAFTA module (320). Consistent with previous embodiments of the related patent applications, another preferred structural characteristic of the embodied HAFTA manifold is barrier-terminated passageway surfaces for containing the flowing gases of the SOC stack assembly.

For advantages that include safety, operating costs, and diagnostics, an aspect of the present invention is the development of centrally located CPG/steam passageways, which are incorporated within the sealed HAFTA structure. Accordingly, a CPG supply passageway structure (315) and a CPG return passageway (316) deliver the condensate-prone gas to and from the active regions (311) of the HAFTA module. Primary inlets (311) are preferably located along a circular edge forming the inner diameter of the HAFTA modules manifold structure (301) wherein cover/separator annulus (321) on opposite sides of the HAFTA manifold structure comprise a part of the surfaces that define the CPG passageways. The primary inlets of the HAFTA module preferably comprises a distributed slotted structure (314) defining such CPG input openings of sealed HAFTA manifold structure.

As with the HAFTA manifold, the monopolar, annular, O2-manifold (304) will preferably also have its manifold features formed into both of the opposing sides of the manifold structure, mirrored about its mid-plane (334) residing between the opposing faces.

A preferred structural characteristic of the embodied HAFTA manifold provides for the most structurally-protected region of the inventive SOC stack to contain the predominant CPG flow manifolding and volume of the system, whereas the preferably oxygen-rich non-CPG gases of the system, such as that produced by the oxygen-emitting side of the electrolyte, are handled by passageways largely confined to the outer region of the annular stack. Accordingly, non-CPG side passageways include supply passageways (302a) and return passageways (302b) located near the inner and outer periphery of the annular array of active regions (411).

Manifolds of the preferred HAFTA embodiments are monopolar and thus handle the gases of one side and electronic polarity of the SOC stack's separated gas/vapor phase redox components. Accordingly, a hole-pattern (317) is preferably formed between the manifold ribs (308) so as to allow free-flow of the manifold's gases between the two, preferably mirrored, sides of the manifold. Such manifold hole pattern allows for higher gas conductance through the manifold passageways while also enabling further weight and thermal mass reduction of the SOC stack. In accordance with the preferred embodiments, the HAFTA manifold provides relatively larger-volume gas passageways than the non-CPG manifold, since the ability for quickly removing and modulating gas compositions of the HAFTA manifold is advantageous for preventing undesired condensate build-up.

Yet another preferred structural characteristic of the embodied HAFTA manifold is structural means in the manifold structure that provide multiple passageways disposed to handle an inert gas flow that is circulating (or alternatively static) within the stack assembly, wherein such inert gas flow, preferably nitrogen, enables both continuous monitoring of seal integrity as well as temporal modulation of the inert gas flow so as to control operation of the stack in a variety of advantageous ways, including regional heating/cooling, modulating inert gas composition for diagnostics, as well as clearing out and monitoring any minute diffusion of gaseous or vaporous species that enter the inert gas stream. It is particularly preferred that such inert gas passageway means provide effective shielding between the SOC gases (e.g. steam, syngas, CO2, O2, etc.) and the atmospheric ambient and working environment of the SOC system. In the present annular HAFTA manifold embodiment, such multiple inert-gas passageways perform multiple functions in ensuring long-term operation and cycling of the device, constructive diagnostics for fast-development of operational modification, and continuous real-time monitoring of seal integrity. Accordingly, multiple passageways (377) providing multiple and separate associated inert-gas flow circuits are preferably incorporated into the manifold structures of the inventive SOC system. In particular, an inner inert-gas passageway (377a) is disposed so as to flood portions of each metallic compliant ring-seal disposed so as to seal the input apertures to the stack-interface section (387) of the center-tube module (371). An outer inert-gas passageway (377d) is disposed in the outer region of the annular manifold so as to provide a continuous passageway that separates the outer seal area of the outer periphery and supply gases of the manifold from the SOC stack's working ambient environment, such that any breach of the outer seal area effecting its active-area gases will result in such working gases first entering the inert gas stream for pre-failure detection via such methods as mass spectroscopy of the inert gas flow.

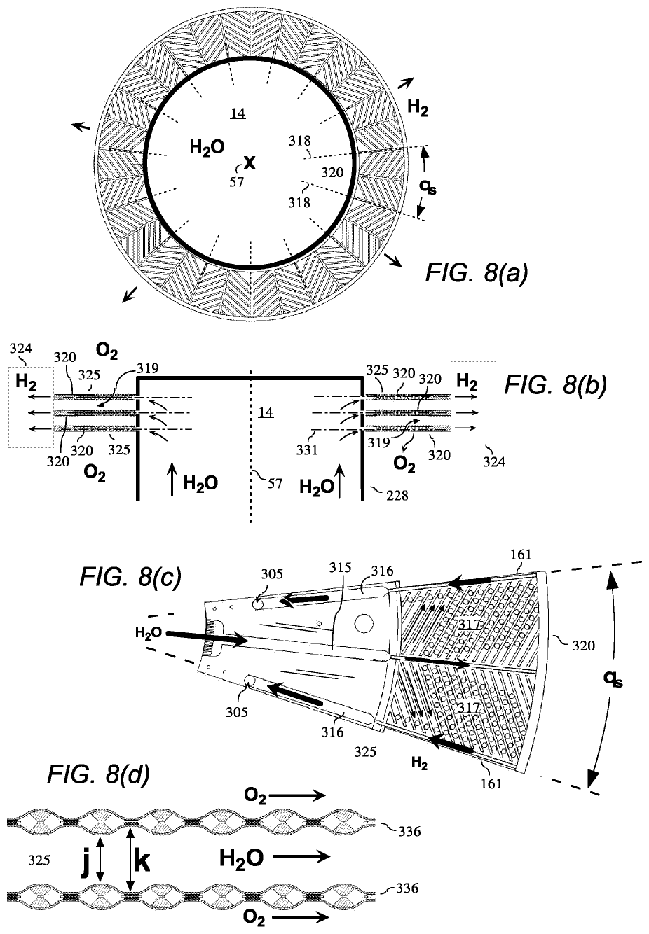

Another preferred structural characteristic of the embodied HAFTA manifold is to provide predetermined apertures that ensure uniform distribution via a staggered set of inlet apertures providing gas into the individual active-region passageways (309) residing between each raised rib (308) of an active-area section (411), that are disposed on either side of both the HAFTA manifolds and the O2-manifolds. Uniform distribution of gas to the active region is preferably accomplished in part via utilization of a staggered sequence of varying apertures admitting gas into each passageway of a particular paired section of the annular active area via staggered-aperture manifold structure (332) located along the radially dividing passageway at the lines (161) dividing the individual active sections (411), in FIG. 13(c) and FIG. 8(c), wherein a steadily tapered profile (333) provides relatively smaller injection apertures closer to the initial introduction point of the incoming gas.

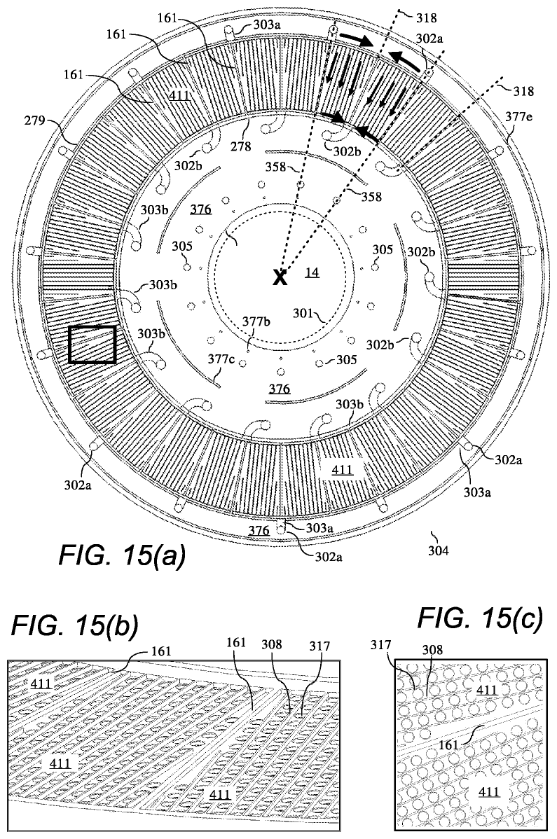

In accordance with earlier embodiments of the individual paired sections of the HAFTA manifold that are each centrally coupled fluidically via the CPG manifold passageways, the present embodiment of the annular O2 manifold similarly is formed with the mirrored annular array of the active ribbed manifolding sections (411) that interface directly to the electrode/electrolyte surfaces. In order to provide separate stack-level manifold passageways that interconnect to CPG and non-CPG (e.g., steam and O2) flow passageways of the endplate assemblies, these stack-level passageways, which are formed in the usual way by the passageway openings formed in the various layers of the stack, are separated in the design of the various thin-sheet stack layers by angularly-staggering the O2-manifold's paired section by one section's solid angle with respect to the HAFTA manifold. Accordingly, the angularly-shifted, paired O2-manifold active sections that are centrally coupled through the supply and return non-CPG passageways (302a)(302b), are delineated by paired-O2-manifold separation axes (358),in FIG. 15(a), wherein these paired sections are angularly shifted by one section with respect to the HAFTA manifold separation axes (318). As with the preferred monopolar embodiments of the HAFTA manifold, and hole-pattern (317) is formed between the mirrored active manifold sections (411) of the O2 manifold, in FIGS. 15(b-c).

Since the annular non-CPG manifold, which separates the CPG-handling HAFTA modules of the embodied SOC stack, will typically be handling the relatively O2-rich-gas side of the SOC's redox half-reactions and processes, such as the O2-production side of a steam electrolyzer, or the air-side of a fuel cell, the non-CPG manifold (304) will be referred to alternatively as the “O2 manifold” in the present disclosure. As with the monopolar HAFTA manifold, it is preferred that the O2 manifold is comprising a mirrored structure formed into either face of the substantially planar and annular O2 manifold, wherein a similar manifold hole pattern (317) is formed in the passageways between the raised ridges (308) of the manifold. Similarly, as the HAFTA manifold (301) is the central structure of the constructed annular HAFTA manifold assembly (320), the O2 manifold (304) is preferably the central structure, in FIG. 15(a-c), of a preferably integral O2 manifold assembly (310). In the preferred embodiments, the annular HAFTA manifold assembly (320) is a modular unit that is preferably containing the electrolyte, catalysts, and CPG-side gas-manifolding of a resultant SOC stack; whereas the O2 manifold assembly is thus a relatively simple separation structure that is disposed to handle the oxygen-rich gas of a resulting constructed SOC stack, the O2 manifold assembly is additionally preferred as a modular assembly that also provides the primary mechanical compliance for ensuring robust electronic contact under a wide range of SOC applications and constructions, more particularly in the form of the embodied micro-compliant assembly.

As is embodied previously herein, a thin separator/cover piece (321) is preferably the outermost layer of material on either face of the embodied annular HAFTA module, where by the completed and sealed HAFTA module (320) will have enclosed passageways formed by the sealing of the thin planar cover-piece to the sealing surface (376) of the HAFTA manifold. The thickness of the thin separator piece is preferably that of established “foil” thickness herein and more preferably a thickness less than 150 micrometers. Whereas the sealing between the separator/cover piece and the manifold is optionally accomplished through highly perfect and planarized surfaces that are compressed together in the SOC stack and which can be freely separated, it is preferred for reliability, reproducibility, diagnostics, and handling purposes, that the seal between the sealing surface of the manifold and the separator/cover be accomplished via high-temperature diffusion bonding as laid forth in earlier patent documents by same author and included herein by reference. In particular, a bonding diffusion pair of the present embodiments is through inter-diffusion of nickel and platinum sub-micron layers to form inter-metallics such as Ni3Pt. The annular separator's inside diameter edge (270) thus extends to the inner diameter of the HAFTA manifold, whereas the annular separator's outside diameter edge (271) is roughly the diameter of the HAFTA manifold as well.

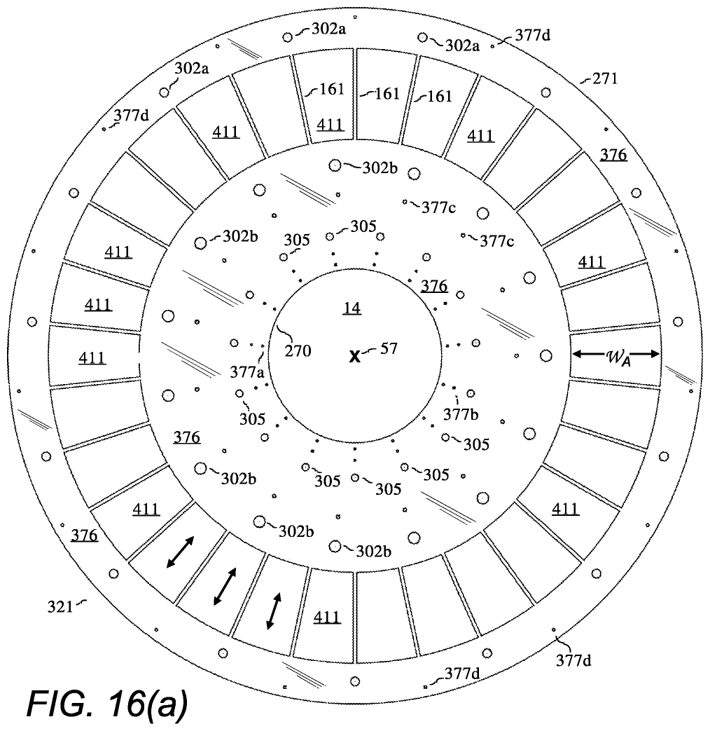

In the first preferred embodiments, the monopolar HAFTA manifold is of the same electronic polarity as the electrode of the embodied thin-film electrode/electrolyte assembly (30) that is directly facing and contacting the opposing faces of the HAFTA manifold, whereas, such articulated pedestal structures as the earlier-embodied separator/cover piece (321), in FIG. 16, that contact the opposite side of the thin-film electrolyte are of the opposite electronic polarity, consistent with its adjacent O2 manifold potential.

The sealed HAFTA module in its preferred embodiment is a self-contained module that is intended to have commercial value as universally applicable to a wide array of applications consistent with the entire known range of solid oxide electrolytes, and accordingly, is embodied so as to have its outermost external surfaces relatively capable and robust for use and handling in the largest possible variety of system manufacturing, system maintenance, and field-inspection scenarios. In order for this robust handling capability to be realized, the outermost surfaces are providing bulk-metal protection--preferably in the form of the separator/cover piece--for the electrolyte/electrode interfaces that are disposed underneath the outer-most surfaces of the assembled annular HAFTA module. Accordingly, in the first preferred embodiments, the externally-facing surfaces of the separator/cover piece are electronically insulated from the HAFTA manifold, such that the active areas (411) of the corresponding separator/cover piece are preferably conducting to currents that are roughly at the potential of the O2 manifold to which it is to be contacted during assembly. As with the electrolyte layer (20) and similar insulating layers of earlier embodiments that are formed over peripheral sealing areas to provide electronic separation, and in certain cases, conformal and encapsulating coverage, the other insulating layers of the various embodiments of the present invention are also formed, preferably by similar energetic PVD/sputtering methods as embodied previously. In particular, the Mg:ZrO2 and magnesium zirconate microcrytalline and nano-crystalline phases are preferably utilized in conjunction with these insulating layers, particularly in a mixed-phase composite of these various phases.

However, in certain alternative embodiments, the electrolyte/electrode structure (30)(17) can be incorporated into the separator/structure itself such that the sealed HAFTA module alternatively possesses no externally-facing bulk metals (including foils) that are maintained at the O2 manifold potential.

With regard to angular alignment of the cover pieces about the central axis (57) of the stack, angular alignment of the separator/cover piece is preferably accomplished via use of ceramic tubes inserted into the N2 or O2 manifold passages of the manifold that are aligning via insertion into the corresponding openings in the various separator pieces.

In certain alternative embodiments, it will be preferred to incorporate more than one layer of the separator/cover-piece that includes an insulator layer that additionally separates the monopolar HAFTA manifold electrically from the monopolar O2 manifold (304).

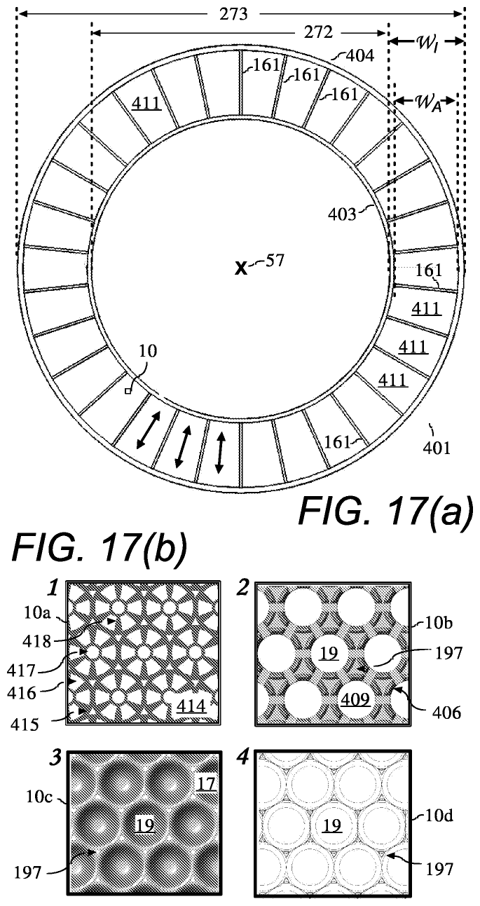

The previously embodied insert-form structure, in FIG. 17(a)-(b), is now more particularly pointed out in more detail as it is utilized in the preferred embodiments. As detailed earlier, components of the embodied SOC stack structure and its subset of manifold assemblies are formed as insertable structures that are aligned to positioned within the manifolds by virtue of mating to registration surfaces and recess features that are incorporated into opposing faces of the respective manifolds. Accordingly, such registration features, namely, the inside diameter edge of annular recess (278) for annular insert and outside diameter edge of annular recess (279) for annular insert, will provide and extend a recess depth to receive thin-walled, annular components in these insert-form annular dimensions, wherein the recess depth is equal to the aggregate thickness of the selected insert-form components that are stacked into the recess, including any sealing layers applied to the inserted components to encourage a high-temperature bond with the appropriate anneal.

As noted previously, the active regions (411) of the various annular articles described in the preferred SOC stack embodiments are accordingly dimensioned so as to provide the identical lateral dimension so as to be functional as a working stack. Accordingly, in the embodied insert structure possesses an annular array of sectioned active regions that are separated at an identical angular spacing (e.g., whether this angular spacing is 24°, 20°, 30°, or, etc) with an identical inner and outer diameter of the annular array of active regions, such that the micro-cell-level features, such as pedestal seating features, passageway sealing features, etc., of each of the layers of the resulting stack assembly are aligned. As mentioned, while pick-and-place methods using machine vision are capable of all alignment requirements, tab features formed into the edge structures (403, 404) may alternatively be utilized by mating these tab features to corresponding recess features formed into the corresponding manifold recess-forming edge-surfaces (278, 279). Whereas active-region section separation features (161) are simply a linear, non-patterned foil surface region in the preferred insert embodiment, this separation feature may also include various machined (via etching, laser marking, etc) features that enable flow channels for various gases as may be advantageous for the various alternative embodiments set forth.

As discussed previously, the insert form (401) is embodied as a structural form having dimensional aspects that are common to each of the various separate insert-form components that are separately discussed in various embodiments, in FIG. 17(b), closed-caption boxes 1-4. In accordance with the preferred embodiments, such separate components are summarized presently, in FIG. 17(b), in regards to their respective functions and active-region structures (411) as the reinforcement contactor foil (414), in box-1, interconnect foil (409), in box-2 (with or without micro-compliant features), or the integrated composite electrolyte/electrode assembly (30)(17), in box-3, or an interconnect foil with same articulation as the support structure (17), in box-4.

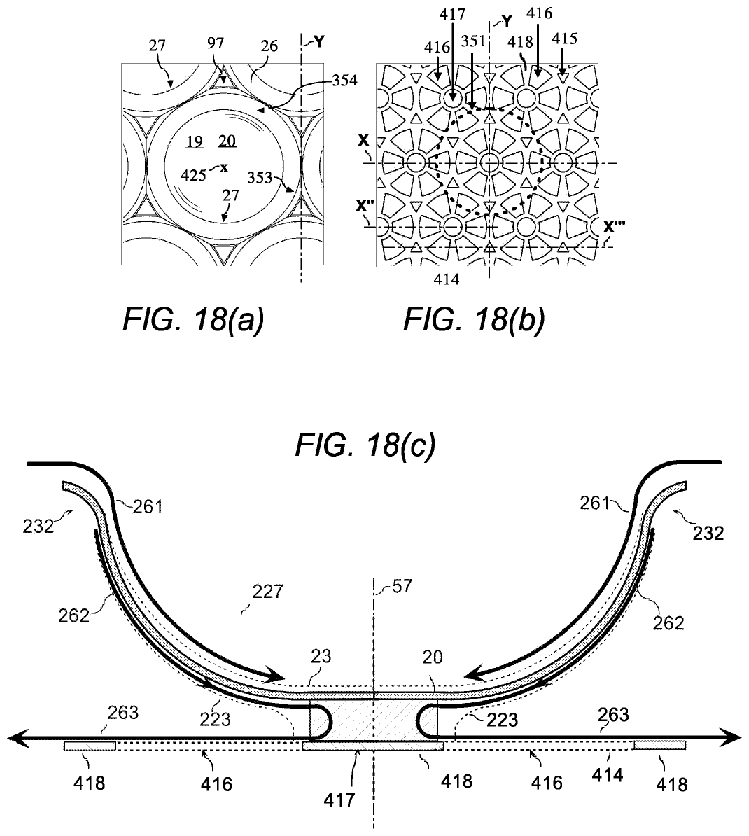

Since the micro-disk is a microscopic structure appearing as a small “dot” under an optical microscope, the reinforcing contactor foil (414) that combines with the micro-disk and electrode/electrolyte structure (30) of the invention, preferably to form the embodied quasi-space-frame aspect of the resulting twinned-dyad structure, such micro-disk is referred alternatively as a “dot” herein. The reinforcing contactor foil preferably includes an etched region forming a dot-contactor-foil pedestal footing (415). The reinforcing contactor foil preferably includes an etched region forming a dot-contactor-foil gas openings (416). The reinforcing contactor foil preferably includes an etched region forming a dot-contactor-foil center-hole (417). The reinforcing contactor foil preferably includes an etched region forming a dot-contactor-foil support tabs (418) forming a radial array of the openings (416) in the foil, in FIG. 18(b), whereby gaseous media are provided high-conductance flow between the opposite sides of the reinforcing foil. Thus, the pedestal footing features of the reinforcing contactor foil, which is preferably thinner than 50 micrometers, will align to the pedestal features (97) on the bottom of the electrode/electrolyte assemblies (30), in FIG. 18(a).

Whereas in previous embodiments of included patent applications by same author, it is embodied that a porous micro-disk (131) contacting the center portion of the freestanding electrolyte (20)(250) will provide additional conduction of the adjoining bottom-side electrode (23) of the electrode/electrolyte assembly, in the present invention, an alternative preferred embodiment of the present invention provides structural means for specifically controlling the conduction path of the bottom-side of the free-standing electrolyte be centered converge to the micro-disk, such that top-electrode primarily is disposed so as to primarily transfer current flow through the outer peripheral region of each electrolyte micro-cell, whereas the bottom-electrode is disposed so as to primarily transfer current flow through the central region and adjoining micro-disk of each electrolyte micro-cell, in FIG. 18(c). Whereas the transition layer is preferably an electrically conductive material, in the present embodiment, in the present embodiment, it is preferred that it is not in electronic communication with the underlying alloy-based structure (17), and is instead substantially insulated from the underlying structure by way of the preferred insulation pedestal cap layer (233), thus resulting in a electrical current path geometry wherein electrode currents of the micro-cell, which are resulting from ion conduction through the electrolyte, are flowing, on both sides of the electrolyte, in either a net-convergent or net-divergent direction with regard to the central micro-cell axis (425).

One result of this embodied current-flow geometry is that due to the substantial removal of the bottom-side electrode's current flow through the preferred asymptotic junction (202) of the microcell, it is accordingly a structural embodiment of the present invention that the electronic conduction currents of the inventive SOC device are substantially isolated and displaced from the intersection of any conducting layer on the bottom-side of the free-standing electrolyte, such as, namely, the transition layer (222), from transferring any substantial current from bottom porous electrode (23) through the inventive annular idler junction's locus of departure (202) that is located at the intersection of the composite layer (227) and the underlying idler-junction bearing surface (234). Whereas the net-convergent (or divergent) current-flow geometry results in many additional operational benefits, this geometry additionally allows for the optimization of transition layer and junctions for their thermo-mechanical function in maintaining SOC reliability and stressing capacity, while at the same time, allowing the condition to prevail that substantial electrochemical activity is not taking place directly within the asymptotic idler junction. Such absence of electrochemical ion conduction at the precise location of the idler junction is further ensured by absence of the primary bottom porous electrode (23) in this junction, but can be further ensured by means of patterned break or delimiting of the contiguous transition layer to the region near the junction structure.

Particularly in the modulated/pulsed and polyphase power embodiments, but also in strictly DC operation, specific pathways and electrode structures provided in the present embodiments are contributing to both higher uniformity as well as higher durability in the operation of the SOC cells and stacks of the present invention. As in previous embodiments, each individual micro-structured micro-cell of the larger annular cell structure will have a characteristic top-side electrode current flow pathway (261) corresponding to the first porous electrode structure (22) on the electrolyte-side of the support structure, as well as a characteristic bottom-side electrode current flow pathway (262) corresponding to the opposite side of the electrode/electrolyte assembly (30) wherein the previously embodied support structure (17) is preferably comprising a conductor at roughly the same potential as the bottom electrode.

In the present embodiments, particularly in conjunction with the embodied reinforcing thin contactor foil (414), as contactor-foil current flow pathway (263) results from conduction through the micro disk (131) that provides electrical communication with the bottom electrode through the central portion of the freestanding electrolyte (250).

In the present embodiment, it is preferred that the preferably electrically-conductive transition layer (222) is not in substantial electrical contact with the top pedestal contact surface that supports the pedestal cap layer, wherein the pedestal cap layer substantially insulates the transition layer from the underlying conductive materials of the support structure. In this way, whereas the support structure/grid-array of the assembly continues, as in previous embodiments, to provide a conductive element in transfer of electrical currents of the bottom electrodes, the bottom electrode current path (262) is primarily conducting currents through the micro-disk, relative to any relatively minute leakage current that may or may not exist through the peripheral junction of the suspended free-standing electrode/electrolyte lamellar composite layer (227).

As a result of the preceding conductive pathway structure, in FIG. 18(c), simultaneously converging and diverging current pathways are resulting in the circular micro-cell structure during operation, wherein a diverging flow of electrons on one side of the electrode/electrolyte lamellar composite (227) will be complimented by a simultaneous converging path of electron flow on the opposite side of the electrode/electrolyte lamellar composite. It will be understood that in an alternating or otherwise reversed flow of current, the pairing of converging/diverging electron flow will also reverse which side of the electrolyte is converging vs which side is diverging, as well as what current-flow convention is chosen. Labeling conventions aside, the present embodiments preferably result in the electron flow in the opposite electrodes of the micro-cell be such that that electron flow is converging or diverging in the same direction, due to the central conductor (131) and according center-to-edge current path on the bottom, convex-side, of the suspended electrode/electrolyte composite layer (227). In this way, several advantages result due to both more uniform potential gradients with respect to varying radial distance from the micro-cells central axis (425). As a result, for example, an intermittent pulsing of the potentials across the entire stack will more readily transfer to uniformly sweeping gradients across each of the pixilated (i.e., micro-cell) electrolyte surfaces of each cell. In addition, potential gradients due to the relatively thin transition layer (222) at the idler junction are avoided, since the bottom electrode is transferring very little, and preferably no current, through the transition layer of the idler junction.

In these present current-flow embodiments, previous limitations to impedance spectroscopy and power modulation methods used in fuel cells and SOEC/electrolyzers of the prior art can be substantially extended to higher modulation frequencies, whereas the inherently higher gradient-uniformity of sweeping potentials will result in far more highly uniform modification of the entire stack operation. Similarly, and as a result of these improvements, the usual useful limitation of such methods to less than 20 kHz can be greatly overcome, wherein local environments of the electrode/electrolyte three-phase boundary may be resolved and modified in frequency realms corresponding more to the electronic behaviors and electron-mobility in the stack, as well as to other relatively high charge-to-mass ratio particles, such as ionized hydrogen whether in gas-phase or in solid-state proton-conduction. This greater frequency range is particularly useful in increasing electronic interactions critical to reaction rate, catalytic activity, sampling rates, surface transitions, resulting ion-conduction, and other such mechanisms that enable stack efficiency and reduce required overpotentials.

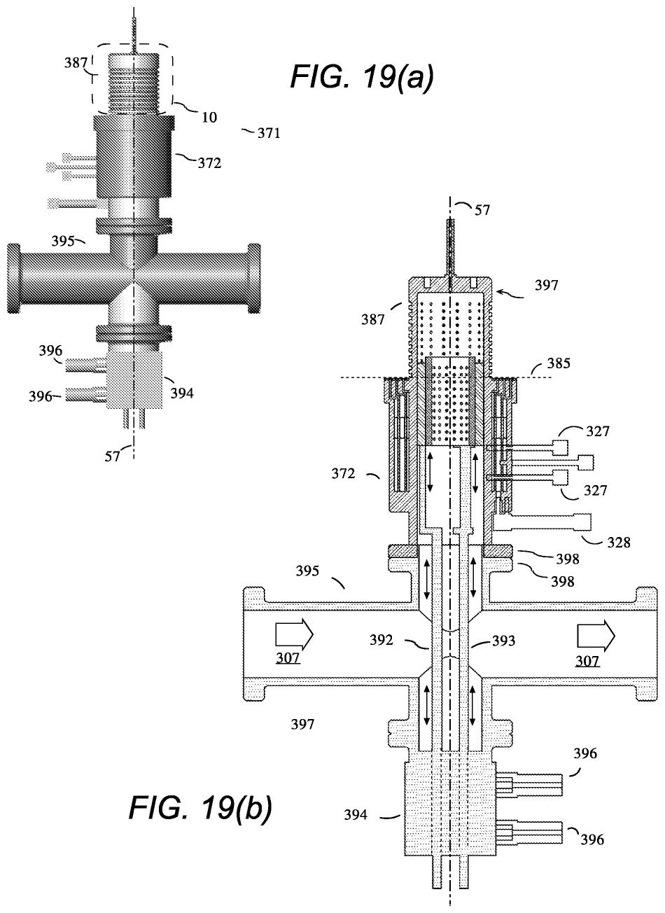

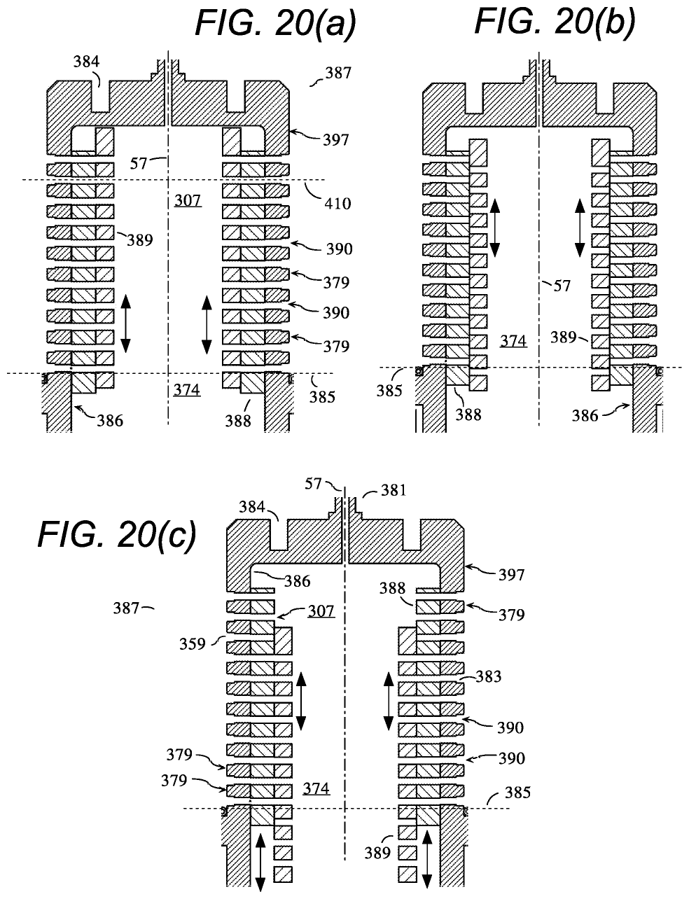

In the overall SOC system configuration, the preferred mechanical configuration comprises an SOC stack assembly that incorporates a valving capability comprising cylindrical shuttles that are activated by means of linear motion means driven by a motorized valve-shuttle linear motion drive assembly (394) integrating linear-drive-motors (396) located below the center-tube (371) which houses the internal cylindrical valve shuttles (388, 389) that perform a low-clearance, sliding-valve function, in FIGS. 19-20.

Center-tube stack-interface cylinder section (387) of the center-tube module comprises numerous features that provide it functional characteristics. In accordance with previous embodiments, a plurality of ports (390) are formed into the stack interface section wherein such ports are disposed so as to align with the angular spacing of injection ports formed in the inner edge of each of the annular HAFTA manifolds. Accordingly, in FIGS. 19-22, a ring array of such angularly spaced ports are existing in the cylinder section for each annular cell of the intended stack assembly, wherein the vertical spacing of each level of ports with respect to the axial central axis (57) of the center-tube module is accordingly equal to the cell-spacing (330) of the utilized stacked-cell assembly (347). The different views, in FIG. 19, for purposes of illustration, correspond to paired-section angular-spacing—i.e., same as the angular spacing between the central steam passageways (315) of the HAFTA module—of the 20-degree (or 30-degree) embodiments wherein the ports (390) are diametrically opposed and symmetrically positioned on either side of the central axis (57) in contrast to the 24-degree embodiment of previous embodiments, wherein the ports spacing is not diametrically symmetric about the central axis.

It is preferred that the center-tube module is demountably inserted and withdrawn from the stack assembly wherein its ultimate positioning in appropriate matching alignment to the stack is accomplished by way of the top endplates annular flange (391). Once positioned, the center-tube module can be additionally retained and fastened by means of using retainer flange (435) for center-tube retainer ledge (375) for more flexible positioning and movement of the center-tube module. In addition, the preferably metal-oxide terminated shuttle elements, which are formed with a similar barrier/oxide combination as the stack insulator, are also readily removed from the center-tube interior without disturbing any of the stack seals.

As discussed herein in conjunction with other embodiments, it is further preferred that the center-tube module be disposed so as to provide housing and functional attributes of an inventive adjoining valve assembly that provides unique advantages as providing an internal manifold valve mechanism within the SOC-stack assembly (350). In accordance with objectives of the inventive valve assembly, the valve is disposed so as to provide individual porting to each active region of each cell, whereby each port of the stack is simultaneously closed via a short linear motion of travel distance that is roughly equivalent to the cell spacing of the stack, whenever desirable. this not only allows unusually high-speed valving of the CPG media to the cells of the stack, such capability also assures that very limited amounts of CPG gases are available for cell interaction subsequent to the moment of valve activation. A purge-port (381) located at the top of the center-tube module is disposed so as to provide various utility including additionally assuring removal of available CPG media within the stack assembly.

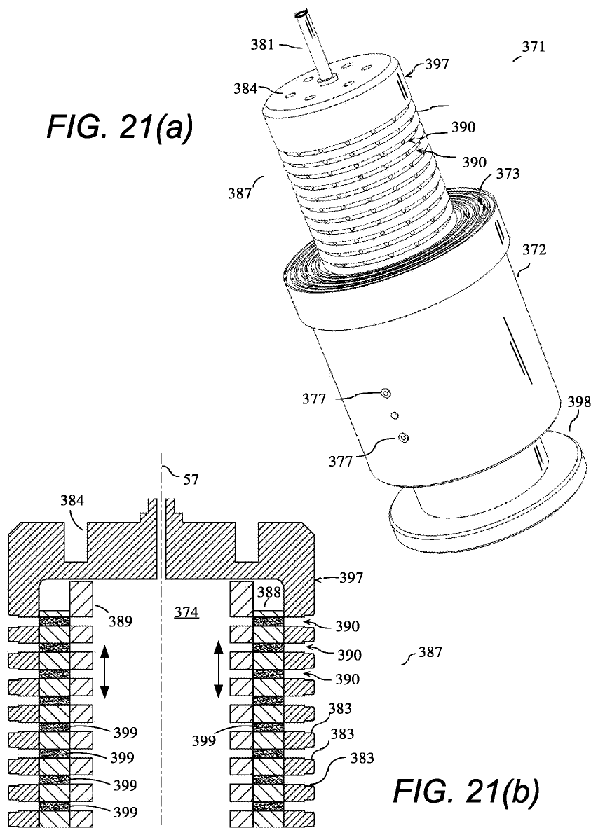

More particularly, the valve assembly preferably comprises cylindrical valve shuttles that perform as valve-gating structures in the valve assembly. A cylindrical main-valve-shuttle (388) is preferably disposed within the Center-Tube interior cavity (374) so as to perform such valve action.

Whereas certain embodiments may incorporate only a single valve-shuttle, in the preferred embodiments, a cylindrical secondary valve-shuttle (389) is preferably disposed, in FIGS. 20(a-c) and FIG. 21(a-b), within the center-tube's interior cavity (374), which is both concentric to and interior to the cylindrical main-valve-shuttle. It is also preferable that the valve assembly includes automated linear motion means, such as embodied main-valve-shuttle positioning post (392) and secondary valve-shuttle positioning post (393), which enable position-sensitive location of the valve shuttles. A single port level (359) that corresponds to CPG input to a single cell level may thus be monetarily throttled or pulsed in its gas input by such means, in FIG. 20(c).

Center-Tube interior cylindrical valve-seal surface (386) is disposed to provide high-precision guidance to equally precision-formed valve-shuttles, wherein it preferred that clearances between these two cylindrical surfaces are maintained at less than 25 micrometers. It is additionally preferred that sealing surfaces are coated with an expansion-matched ZrMgO compound of the structure and compositions disclosed in the preferred graded-barrier disclosure included herein by reference.

Looking now to more particular embodiments of the center-tube/valve assembly, it will be understood that a primary advantage of a demountable stack assembly is to counteract the considerable cost inherent in permanent sealing techniques that are commonplace and standard in the field of solid-oxide cells and stacks. Whereas past patent literature by same author introduced demountable seal embodiments, a particular advantage of the present invention is that its inventive embodiments enable a hierarchy of demountable surfaces so that basic components that are typically permanently integrated into a normal SOC stack of the prior art can be readily removed, serviced and/or replaced quickly without disturbing seals of the remainder of the SOC stack. After removing or before replacing the SOC stack assembly, the center-tube assembly, in FIG. 19(a-b), is therefore available for inspection, repair, and/or replacement. In its first preferred embodiment, the stack is separately hot-boxed in a series of hot-boxed stacks in a daisy-chained series of such stacks.

The orientation of compliant metal seals in the embodied SOC stack assembly enables a swaging action upon inserting the cylindrical center-tube's stack-interface section (387) into the SOC stack assembly, wherein a series of ring-shape compliant metallic seals hermetically separates the CPG flow (307) from the non-CPG manifold assemblies (310) that are adjacent to CPG-containing surfaces of the HAFTA modules. Such compliant ring-seals are preferred to comprise a hollow-o-ring seal (preferably of open “C” type cross-section) that are commercially available for high-temperature sealing operation from multiple commercial vendors. Preferably the metallic seals are surface terminated with a Pt-terminated barrier layer as embodied herein, and are composed of a low-expansion Ni-alloy such as Inconel 718 or 750-x.

An annular center-tube top-flange (391), utilizing and fastened by the center-Tube bolt-pattern (384), provides means to draw the center-tube module into an alignment position with regard to the manifold ports.

The center-tube module (371) can alternatively be an expansion-matched, compound assembly wherein the metal-jacketed region (lower section) is sealed to a ceramic (e.g. zirconia) stack-interface section (upper section).

Sealing by high-temperature metal gaskets of the endplate assembly's half-manifold endplate adapter (364) of the stack assembly to the center-tube module is accomplished at the mating center-tube seal plane (385) that designates the sealing interface between center-tube module to the embodied SOC stack assembly. Accordingly, the sealing flange of the center-tube module contains multiple ring-shaped seating grooves that each comprise a metallic-seal seating groove (373) for seating compliant metallic seals (363) of the earlier-embodied SOC stack/center-tube assembly.

It will be understood that the first shuttle is sufficient for the functions embodied of in-stack shut-off at individual cell-manifold level, as well as to quickly modulate gas flow in a variety of low and high frequency or pulsed input schemes. Additionally, the motion-drive assembly for translating the shuttles is also capable to rotate the shuttles with respect to the center-tube module, so that innumerable ranges and matrices of port patterns in the shuttle structure may be utilized.

As discussed in conjunction with earlier preferred embodiments herein, aside from throttling capabilities of the valve assembly, it is an alternative preferred embodiment that permanent pressure throttling structures (390) are utilized in the vicinity of the CPG injection locations (311) located at the inner-diameter edge of the HAFTA modules, in FIG. 21(b). In addition to the distributed slot-type apertures (314) embodied, additional expansion-matched porous materials, preferably of the a metal-oxide matrix, are also utilized in as a “porous-plug” that additionally throttles and potentially pre-filters the incoming CPG media at throttle locations within the SOC stack-assembly. Such porous materials can be disposed in the distributed-slot region of the HAFTA manifold's CPG injection locations; however, they are preferably located within the valve assembly, either in ports (390) or in the valve shuttles, so as to provide low-cost maintenance and inspection of such porous throttle-plugs (399), in FIG. 21(b). More preferably, such porous/frit plugs are located within the first main valve shuttle (388), rather than in the center-tube ports, so as to be readily replaced or monitored.

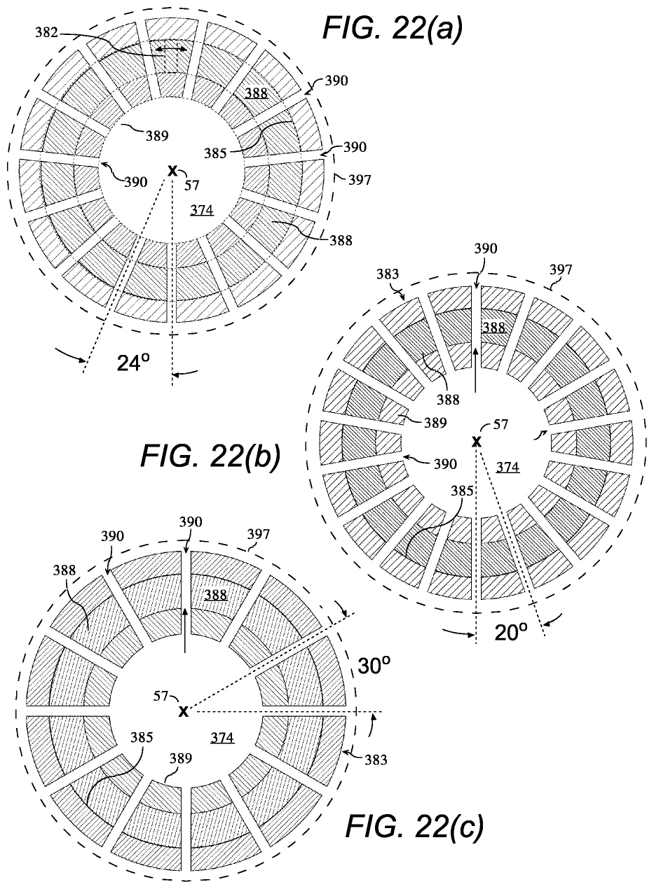

Accordingly, in FIGS. 22(a)-(c), a single level of the ring array of such ports (390) will be angularly spaced about the cylindrical stack-interface section (387), preferably in accordance with the angular spacing of various active-region sections (411) in the cell manifolds and associated interconnection foils (229, 321, 409). Such angular spacing is preferably selected to allow equal angular spacing around the annular embodiments of the device, and preferably in the range of 5-degrees to 30-degree spacing, partly depending on the diameter of the cells being produced. Whereas the angular spacing utilized in previously discussed preferred embodiments is 24-degree spacing of FIG. 22(a), since this allows sectional planes through central axis (57) that display both port-aligned and non-aligned regions of the stack. However, in alternative preferred embodiments, the port-spacing is of diametric symmetry, in the 20-degree and 30-degree port-spacing examples, in FIG. 22(b) and FIG. 22(c). Both the 24-degree and 20-degree embodiments are set forth herein as appropriate embodiments for teaching the invention. Accordingly, a sectional plane through the port-centers, in FIGS. 20(a)-(c) and FIG. 21(b), is taken through a 20-degree center-tube module, so that it is symmetric about the central axis.

As indicated in FIG. 22(a), alternative valve-shuttle port-openings (382) may also be located in the valve-shuttles so that an valve-shuttle motion control will also include shuttle rotation/positioning capability for utilizing either ports using the throttle-plugs or alternately port not using throttle plugs. Alternative pot-openings accessed by shuttle rotation can also be utilized to block or access only specific injection ports in a single HAFTA manifold.

As presently embodied, the inventive high-temperature, stack-manifold-integrated, valve assembly of the embodied SOC system can therefore provide a wide array of functionalities useful in both system operation as well as in real-time system diagnostics. These functions embodied include but are not limited to: short-distance (i.e. less than 5 mm) valve-gate actuation; high-speed modulation of CPG media flow; cell and even sub-cell-level diagnostics and operational modification via high-speed (sub-second) modulation of CPG flow; safety capabilities of providing sub-second-capable valving that separates manifold volumes from individual cell passageways, minimizing available fuel/energy available to cell operation; real-time diagnostics or cell-isolation that can isolate cells of the stack during working operation; diagnostics in conjunction with inert-gas passageway monitoring (compositional or other diagnostics) that enable pin-pointing 3D location of any failing or malfunctioning seal in the stacked-cell assembly (347); diagnostics possibly in conjunction with inert-gas passageway monitoring (compositional or other diagnostics) that enable pin-pointing 3D location of degradation/anomalous behavior in a localized region of the electrolyte/electrode assemblies of the cell-stack assembly; and, various other advantages as may be apparent in conjunction with the present disclosure.

With regard to stack-interface and the external cylindrical surface (397) of the center-tube module's stack-interface section (387), under certain application wherein alternative embodiments are particularly advantageous, the features formed into this surface and the composition of this cylindrical surface will be differently embodied from these first preferred embodiments. For example, the exterior ring-shaped slot features (383) formed into the cylindrical surface of the stack-interface section (387) may be omitted when secondary and alternative port openings are desired for optional rotational selection of ports on the same valve-shuttle structure. In the preferred embodiments, the external cylindrical surface performs as a sealing surface such that the high-temperature metallic ring seals (363) that confine incoming steam (or other CPG) to the designated CPG passageways by sealing between the outer surfaces of the annular separators (321) comprising the outermost surface of the adjacent HAFTA modules, in addition, also contact the external cylindrical surface (397). Individual annular sealing surfaces (379) of the stack interface section are thus disposed so as to both retain the preferred hollow metal C-rings (or O-rings) as well as to block passage of the CPG medium between adjacent annular SOC cells of the stack; whereas these ring-seals more directly are compressed and provided hermetic seal against the opposing faces of each HAFTA module, or alternatively, other annular SOC cells of an alternative SOC stack.

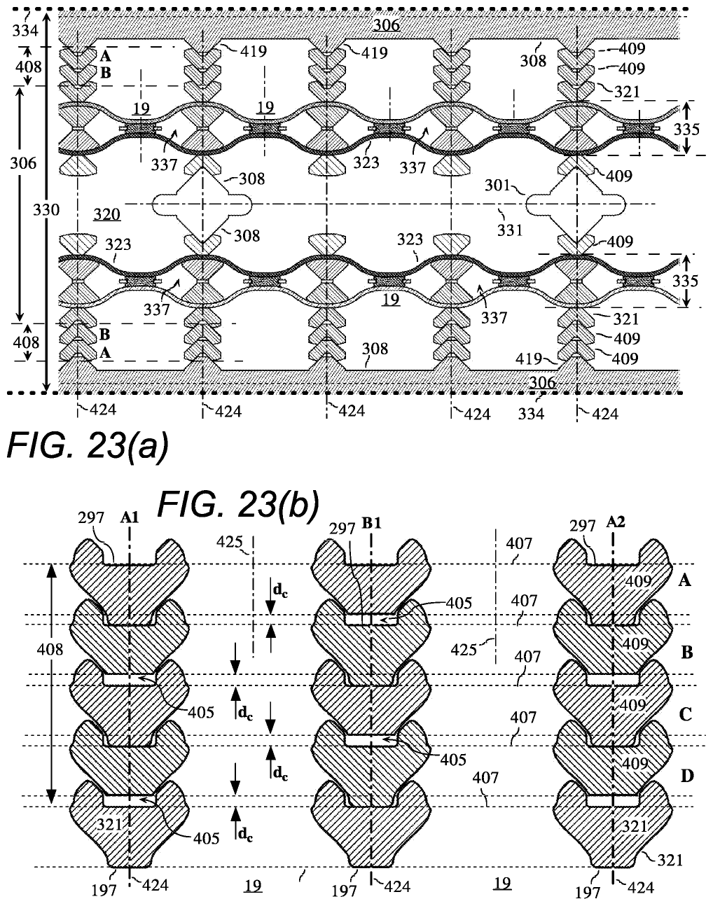

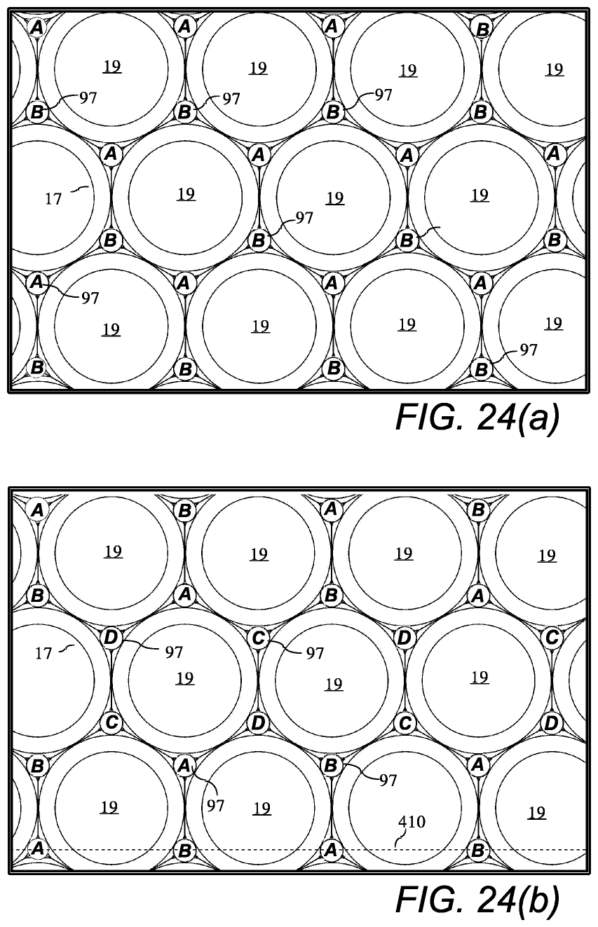

In a preferred alternative embodiment of the inventive SOC stack assembly, the oxidizer manifold assembly additionally incorporates inventive micro-compliant structures forming a micro-compliant assembly, in FIGS. 23-24, that is disposed on at least one of the interfacing sides of the oxidizer manifold assembly.

In a preferred embodiment, mechanically-compliant means that possess a mechanical restoring force (or an effective spring constant) are particularly incorporated into the embodied O2 manifold assemblies that are disposed within the clearance spaces (319) that reside in between the successive HAFTA modules (320) in a SOC stack assembly of the invention, preferably embodied as a coupled series of at least two micro-compliant foil layers having the embodied micro-compliant features, such as foils “A” and “B”, in FIG. 23(a), which are preferably a layered assembly disposed bi-facially within the annular recess features of the inventive O2 manifold (or non-CPG-side manifold) assembly (310) that interleaves the HAFTA manifold assemblies of the preferred embodiments.

In the first preferred embodiment of the micro-compliant assembly, in FIG. 24(a), a single uniformly micro-compliant assembly is comprising at two such micro-compliant foils (409), A and B, in stacked form and are disposed such that intermittent modification of these pedestal-probe surfaces (97) provide a restoring force preferentially along the axes (424) of the stacked pedestal/probe alignment, in FIG. 23(a). It is preferred that the layer-wise micro-compliant displacement (405) at the shortened pedestal is due to this staggered locations of a pedestal clearance, d_{c}, relative to its three neighboring pedestals in the hexagonal grid array. Thus, in an appropriately sequence 2-layer stack of such foils, each axis (A1, B1, etc), of the stack can correspond to the same number of alternating shortened pedestals with the clearance, d_{c}, whereby each vertically-aligned, along vertical axis 424, sequence of pedestals provides an identical displacement and restoring force, due to one pedestal in the vertically-aligned sequence of pedestals in the stacked foil components being selectively shortened whereby the clearance space is formed in that pedestal-seating location.

More particularly, it is preferred that such mechanically-compliant means comprise the primary mechanically-compliant means of the inventive SOC stack assembly at the individual cell level, wherein the micro-compliant structure is using a predetermined and periodic 3D array of the embodied stacked grid/pedestal features of the interconnection foils embodied previously, wherein the micro-compliant foils are containing contacting probes of differing lengths, and preferably, two distinct lengths, such that each stacked probe axis (424) of this dense micro-compliant assembly (408) of the pedestal-probes corresponds to an identical restoring clearance (405) and restoring force provided predominantly in the direction of the probe axis (424).

The desired, unidirectional and uniform restoring force of the micro-compliant assembly is preferably resulting from the placement of the described shortened-probe locations (shortened by distance d_{c}) of the resulting 3D grid in alternating positions within the normal, un-shortened pedestal-probe array of previous interconnection foils. Such alternating positions of the shortened pedestal probe-pedestals are designated by a relative probe clearance (405) that results from the modified and shortened probe, relative to the seated position of its adjacent pedestal-probes, wherein such alternating positions may alternate according to one of multiple periodic configurations within a particular micro-compliant assembly.

This micro-compliant arrangement of modified pedestals is similar to certain periodic possibilities realized in the group theory of periodic arrays of basaltic hexagonal planes that posses an ordered crystal lattice in three dimensions, via a particular repeating 3D arrangement of two (or more) distinct positions (e.g., positions of the modified-pedestal positions, relative to non-modified pedestal positions) that are hexagonal in arrangement in each hexagonal basaltic plane (e.g., the micro-compliant foil is acting as a hexagonally structured plane), wherein, in the present micro-compliant assembly, the hexagonal planes are staggered with respect to their adjacent hexagonal plane in the same in-plane axis by a pre-determined integral number of the hexagonal pedestal positions (424). Such periodic staggering of the hexagonally-structured planes, when appropriately selected, will result in a specific periodic array of the modified-pedestal positions in the respective planes, such as viewed along the vertical pedestal-seating axes (424) in FIGS. 24(a-b). These present preferred embodiments of the micro-compliant assembly result in an equal number of the modified pedestal positions in each vertical pedestal axis (424) of the described micro-compliant assembly. Such assemblies (e.g., the 2-layer or 4-layer assembly) can then be stacked for greater mechanical compliance displacement (N-assemblies multiplied by d_{c}) under the given mechanical restoring force (spring constant) of the specific micro-compliant assembly.

For example, in the present inventions, as second 3D geometric configuration of the modified/shortened probe-pedestal lengths are provided in a four-layer scheme comprising micro-compliant foil layers A, B, C, D, in FIG. 23(b), taken through section plane (410) of FIG. 24(b) wherein the position of modified probe positions in such a A-B-C-D sequenced four-layer scheme is shown schematically such that the notation indicates the foil layer (A, B, C, D) at which the modified-pedestal is located for that notated pedestal position; and, accordingly, such that the modified probe-clearances are similarly disposed at periodically alternating positions within a similar 3D-stack of hexagonally formed pedestal-probe arrays. Thus, for a given micro-compliant foil structure, clearance, de, thickness and material, the present 4-layer scheme will provide a smaller per-unit-thickness micro-compliance as well as a larger spring constant, or stiffness, due to the relatively high number of cross-members that are being elastically flexed while providing a restorative force for a given clearance, d_{c}. In addition, the 4-layer scheme will provide more locally-isotropic and limited strain along the lateral axes of this 4-layer micro-compliant assembly, due to the more dispersed and randomized nature of the resulting roughly cubic symmetry (i.e., the 4 positions—A,B,C,D).

The number and configuration of micro-compliant layers in a micro-compliant assembly can be pre-determined within a wide range of possible requirements, dependent upon specific SOC stack application and construction. In the present preferred SOC stack embodiments that utilize the micro-compliant assemblies, a micro-compliant assembly will be a single two-layer micro-compliant assembly of the presently preferred two-layer, A-B, embodiment, wherein such two-layer micro-compliant assembly is incorporated as a bifacial assembly that is accordingly integral to the two opposing faces (i.e., bi-facial) of the embodied O2 manifold assembly, in FIG. 23(a), such that an annular HAFTA module of the preferred embodiments will accordingly interface and align its own pedestal array to the pedestal array of the O2-manifold assembly's micro-compliant assembly (408).

It is thus preferred that the micro-compliant nature of these probe/pedestal arrays results in a relatively small and well-defined displacement range that enables relative precision in the interconnection properties that result; particularly, it is preferred that restorative micro-compliant displacement Dₘ herein be defined to be such that 0.005 mm<Dₘ<1 mm, and for optimum electrical interconnection in precision-manufacture SOC stacks, further limited in displacement such that, 0.005 mm<Dₘ<0.2 mm, as defined by the pre-determined available restoring flexure clearances (e.g., an integral number of displacement dimension, d_{c}, allowed by the micro-compliant assembly (i.e., not including displacement due to plastic deformation nor non-restoring deformation).

For example, in the exemplary embodiments of a micro-compliant assembly (408), multiple annular-insert-form layers of the preferred rolled-alloy foil, having the earlier-embodied inner diameter and outer annular diameters (272)(273) of the earlier-embodied annular insert form (401), such that the micro-compliant assembly is disposed substantially within the recess of the oxidizer-side manifold (304) insert-form recess. The inner diameter edge structure (403) and outer diameter edge structure (404) of the various embodiments (229, 409, 30) of the previously embodied generic annular insert-form structure (404) will alternatively incorporate an edge tab for aligning the angular orientation of the inserts so that the pedestal features of each of these respective components are readily aligned to each-other by inserting into the respective manifold insert recess features delineated by recess edges of the manifolds.

As viewed from a plan view, the preferred hexagonal hole pattern of the preferred grid structure possesses a pattern of pedestal seating surfaces (97) such that each such position of pedestal-seating surfaces preferably has an adjacent three pedestal seating surfaces arranged at 120-degree space around the instant surface in question, in FIGS. 24(a-b). When the instant pedestal seating surface in question is fabricated with a marginally shortened depth, relative to its surrounding three pedestals, the resulting limited clearance, d_{c}, results in the ability for the instant pedestal feature to be displaced by said clearance, d_{c}.

It will be seen that whereas the first preferred embodiment of A-B modified probe positions provides for the cited “tripod” configuration of micro-compliant clearance to be implemented via a repeating, alternating sequence of shortened-pedestal patterns A and B, in FIG. 24(a), the alternative 4-layer sequence of layers, A-B-C-D, in FIG. 24(b), possesses half the displacement clearance (per number of micro-compliant layers) of the preferred, two-layer A-B embodiment. Thus, multiple possibilities may be realized to provide different displacement clearances and different spring constants of the associated micro-compliant restoring force of the micro-compliant assembly, whereas the displacement along each probe-pedestal axis (424) of the micro-compliant assembly is preferably equal and uniform due to each vertically-aligned row of pedestal positions of the respective alloy components is corresponding to an equal aggregate number of the staggered clearances, d_{c}, as provided in the embodied micro-compliant assemblies.

Whereas precision dimpling may alternatively be used to instead deform the foils in a similar arrangement, such dimpling/deformation is less-preferred as it offers neither the precision nor the high-temperature reliability of the present micro-compliant foils, which are preferably formed by subtractive forming of the desired and articulated form of the micro-compliant foil, either through the particularly preferred resist-patterning/chemical etching/polishing methods outlined for the electrode/electrolyte assembly (30)(17), or through other such subtractive forming methods such as laser machining/marking methods. Alternatively, additive methods such as 3D printing may also be utilized.

Whereas the probes of the micro-compliant array are preferably isopotential in voltage, due to the electrical continuity between all parts of the 3D array, it may be alternatively realized that an insulating glass or ceramic insulator is utilized instead of a foil wherein each probe corresponds to a separate conductor circuit.

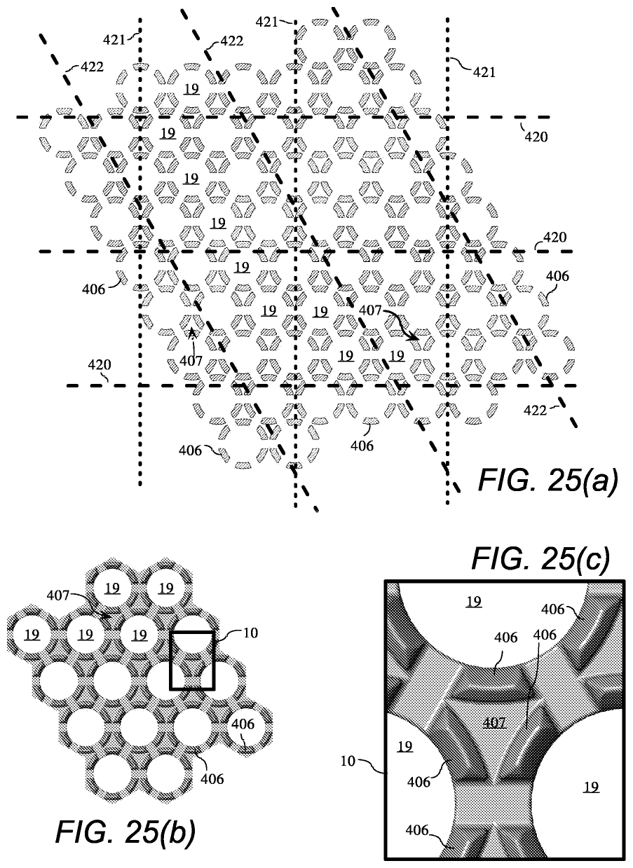

In one alternative preferred embodiment of the inventive micro-compliant assembly, the individual layers of the micro-compliant assembly is articulated in a fashion similar to the alloy-foil structure of the electrolyte supporting grid (30)(17), such that it possesses pedestal seating surfaces (297) that comprise a specifically-structured pedestal seating surface and seating level (407) that incorporate adjacent guiding surface-features (406) that will capture the pedestals of adjacent micro-compliant layers, wherein the pedestals of these micro-compliant layers (409) are aligned and centered along the same pedestal axes (424) that are aligned to the pedestals of the electrolyte supporting grid (30)(17), while providing enhanced electrical contacting for reliably low ohmic losses. In the micro-compliant assembly, clearance is provided between the pedestal bottom and its pedestal seating surface at certain regular intervals of this articulate grid structure such that a tripod configuration is preferably created between a shortened pedestal and its three immediately adjacent pedestals in order to provide a restoring spring force in the assembly, in FIG. 24(b). Such guiding surface-features (406) are preferably formed by resist/pattern/etching/electro-polishing as previously embodied. Alternatively, such features are formed by means of modifying previously formed interconnection foils (409) by means of 3D additive manufacturing such as provided by the 3D printing of the additional features onto the already etched/patterned/polished foil structure by means of laser 3D printing of the features via 3D printing methods compatible with printing inter-metallic alloys or ceramic compounds that are expansion-matched to the existing interconnect foil. Similarly, such compounded fabrication approach of secondary 3D-printing of additional features may be utilized in conjunction with any component embodied herein. For example, in FIG. 25(a-c), the guiding surface-features (406) may be formed by first patterning the existing interconnect foil with a binder-infused material that is subsequently processed and sintered (e.g., transitioned from a “green” ceramic state to a sintered ceramic state) to provide an integral structure having the desired additional pedestal-guiding features. Similarly, laser-based 3D printing may also be utilized for similar results. In these various 3D-printing embodiments, the pre-existing structure, such as the embodied interconnect foil, will preferably have layers formed over the underlying alloy comprising the preferred thin-film barrier structures, in addition to adhesion-enhancing layers that are tailored for the specific 3D-printed materials being formed, preferably wherein inter-diffusion of atoms between the 3D-printed materials and the underlying layers is accomplished during the sintering step.

Whereas electrical circuits of the inventive SOC stack may be implemented in accordance with any variety of electrical interconnection schemes appropriate, as is widely disclosed in the prior art of both the SOEC and SOFC applications of SOC stacks, a particular interconnection structure and methodology is embodied herein for exploiting particularly advantageous operational attributes that are specific to the other advantages and preferred embodiments set forth herein. As set forth in conjunction with the inventive HAFTA modules and geometry, certain cyclic power conditioning is uniquely applied in either power inputs provided to the SOC stack assembly during electrolysis mode, or in power output impedance that is implemented in SOFC mode.

Specifically, it is preferred that each annular HAFTA module of the first preferred embodiments is electrically connected to its external circuitry by means of an angularly spaced array of contact tabs arranged about the outside diameter of each cell, wherein the thermal heat-sinking that results from electronic connection is thereby uniformly applied in a centrosymmetric fashion by the plurality of equally-spaced contact tabs. In addition, several operational modes are enabled wherein cyclic potential gradients (431) can be made to laterally circulate within an annular cell as is realized by appropriately phase-shifted power or similarly phased impedance-matching to the angularly spaced tabs, depending on whether in a power-in SOEC mode or in power-out SOFC mode of operation.

Various operational modes are thus provided by means of applying an alternating voltage potential of predetermined frequency, band-width, and phase-difference between the adjacent tabs (427, 428) of a particular cell on either or both the annular CPG electrode (427) or the annular non-CPG electrode (428). Variable frequency drives (VFD's) of either three-phase (e.g., 120-degree phase shifts) or poly-phase (e.g. 30-degree or other phase shifts) can be cycled about a single annular electrode such that lateral voltage potentials are sweeping the cell at a pre-determined frequency. Such cycling has many potential benefits, ot only in diagnostic windows, but also in both lifetime and power-density, as well as in preferentially enabling certain surface reactions while preventing other, degrading reaction. Such cyclic potential gradients via low-to-high frequency power cycling enables an almost infinite realm of possibilities in pulsing, harmonics, beat-frequency creation, lateral (in-cell) voltage, and other time-limited and/or mobility-limited interactions for reducing unwanted phase formation, unwanted reactions, or unwanted morphology transitions in the porous electrodes of the devices.

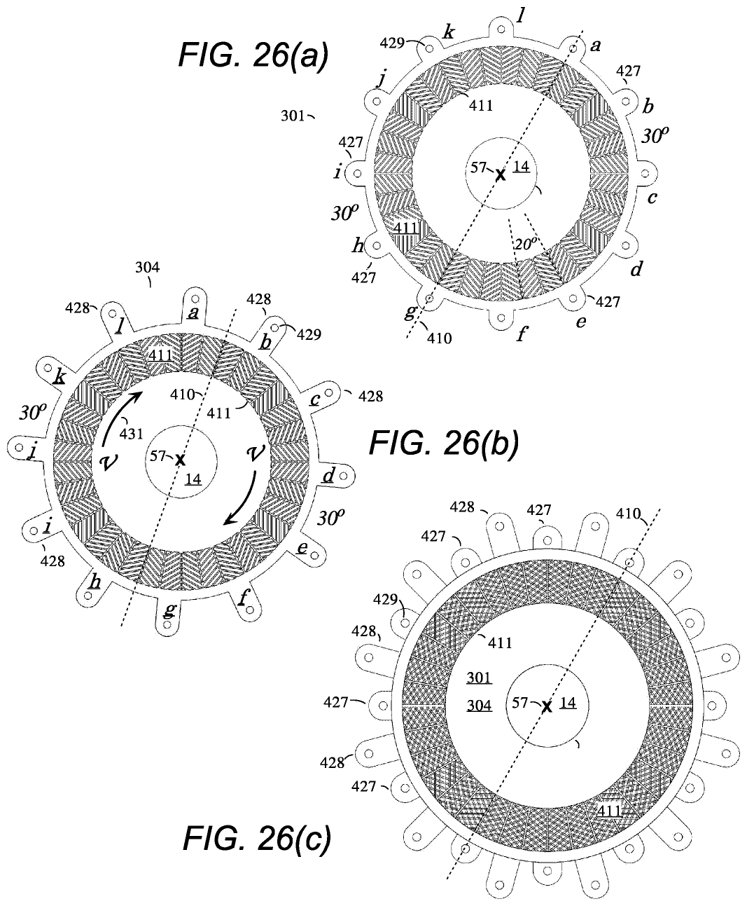

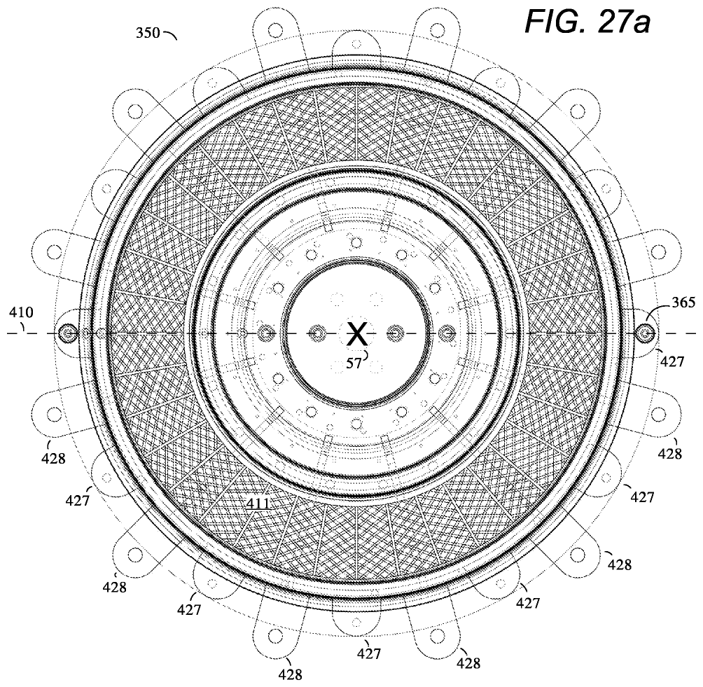

In particular, in one exemplary embodiment, in FIG. 26(a-c) a circular array of tabs is radially protruding from the annular conducting structures of the cell wherein electrical contact tab of CPG-side tabs (427) of the cell are regularly space in an array, a-1, each tab separated by 30-degrees; and likewise, (428) electrical contact tab of oxidizer side (428) of the cell are regularly spaced in an array about the cell, a-1, each tab separated by 30-degrees. Whereas the CPG/steam manifold having the presently embodied phased array of contact tabs (427), in FIG. 26(a), and non-CPG manifold having its own phased array of contact tabs (428), in FIG. 26(b), are each formed so as to have electrical fastener holes (429), it is preferred for present embodiment that the fastener holes of the CPG-manifold, which is preferably that of the sealed HAFTA module of earlier embodiments, is aligned to the bolt pattern (365) of the SOC-assembly, in FIG. 27, since in the first preferred embodiment, the SOC stack assembly is most economically operated such that the CPG/steam manifold and the SOC stack endplates are maintained at the potential of the CPG/steam manifold. As embodied, it is preferred that the contact tabs of the non-CPG manifold extend to a larger radius relative to the opposite electrode and are staggered so as to be equally spaced between the oppositely-poled tabs of the CPG-side manifold, when stacked and aligned in the SOC stack assembly along the SOC central axis (57), in FIG. 26(c), wherein the present preferred exemplary embodiment is utilized in conjunction with the “hexagonal” manifold rib arrangement of earlier embodiments. However, those skilled in the art will understand that such phased-array tabs can be spaced in innumerable schemes so as to interact with poly-phase power modulation of the stack, both for affecting operational SOC characteristics in working operation, as well as for real-time diagnostics in the manner of impedance spectroscopy and other frequency-based methods.

Whereas forming the electrical connection tabs into the manifolds themselves is embodied herein for exemplary purposes and clarity of description, it should also be appreciated that the contact tabs of the present embodiments may also be disposed so as to be instead integral to the various interconnecting foils of the preferred SOC stack embodiments, such as the separator (321) of the HAFTA module, or larger-diameter versions of the various annular insert-form and/or micro-compliant assemblies, such that it is these thinner foil-like components of the stack that provide electronic connection to external electrical equipment of the relevant installation. The specific annular components of the stack chosen for tab-formation will be determined in part by the specific application and power density needed, since higher power density operation will tend to make the thicker manifolds of the stack a preferred choice for higher current transport.

In the present exemplary embodiments, in FIGS. 26-27, operated in electrolysis mode, a phase-shifted variable frequency drive provides an electrically floated cyclic potential, V, to these tabs such that twelve separately phased alternating power characteristic at a frequency, o, each phase shifted 30-degrees from the adjacent phase of the 12 phases, are applied to the respective 12 tabs. for example, a an alternating power signal may be modulated at the frequency w wherein the applied voltage is varied between a selected over-potential voltage and a lower voltage somewhat below the over-potential (or even reversing the voltage to an opposite polarity). Alternatively, a simple 3-phase power conditioning may be applied such that each single phase is applied to four out of the twelve tabs. Obviously there are an endless possible arrangements for implementing a variety of waveform characteristics, beat-frequencies, harmonics, and gradient structures in a manner analogous to the multiple possible vibration modes of a circular drum head or of a resonant cavity, where the precise structure and compositions of the annular stack will result in particular impedance characteristics. However, the annular symmetry enables a frequency response to phase-shifted frequency that is far more conducive to uniformly controlling the electrochemistry across the annular cell, relative to the inherent non-uniformity of applying such alternating signals to a standard square or oblong stack shapes of the prior art. In some cases, the higher symmetry of the embodied SOC stack may result in commercial utility in using unusually high frequencies (e.g. kilohertz to gigahertz) that enable plasma-like interactions and mechanisms to occur within the cells, thus modifying and enhancing normal electrolytic boundary layers and three-phase boundaries with enhanced activity such as due to additional, plasma-like activity, increase radical or ion creation, increased electron collision rates, and other such increase chemical activity due to increase mobility and molecular/electron coalitional energies, etc.

Whereas in the context of normal SOC stacks of the prior art, one can discuss the application of impedance spectroscopy methods and similarly apply (or extract) power by means of modulating such power at frequencies commensurate to those of impedance spectroscopy methods (e.g., hertz to megahertz), it is nonetheless completely impractical to discuss such power modulation in the context of a deterministic and necessarily roughly-uniform modification of chemistry across the cells of such prior art SOC devices. Not only are the non-symmetric geometries of such prior art stacks not conducive to anything other than low frequency power modulation, due to geometry-dependent impedance effects at higher frequencies (e.g., a kilohertz or higher), but also the relatively thicker electrolyte layers involved will similarly be less responsive to higher-frequency modulation. Thus, a micro-SOC of sub micron electrolytes in the embodied geometry is particularly conducive to the uniform application of higher frequencies that uniformly sweep and deposit power uniformly to the embodied symmetric annular active regions of the present invention. In this way, boundary regions of the three-phase boundaries, reformation areas, and other active volumes of the electrode interfaces can be advantageously affected, similarly, sampling rates of those boundaries can be uniformly and advantageously increased so as to greatly increase catalyst activity and decrease reaction or chemisorption-limited (adsorption-limited) rate-limiting processes in the cell.

At the same time, compound-semiconductor-based (SiC, GaN) inverters are significantly lowering the cost of efficiently obtaining high frequency power conditioning that would enable efficient generation/conversion of energy by these embodied polyphase, higher-frequency power conditioning methods.

For example, DC-biased “high-frequency” modulation in the range of several tens of kilohertz can be utilized to significantly and preferentially increase electron mobility and electron collision rates in the spatial vicinity of the well-known three-phase boundaries of the SOC's electrode/electrolyte interface, whereas ionic mobility's at this interface are responsive primarily to the dominant over-potential provided by the DC biasing of the power conditioning, such that electrolysis is performed with effectively higher solid-state ion conduction and overall device efficiency, due to catalytic and interfacial processes being greatly accelerated due to far higher electronic collision and sampling rates in the various chemical interactions that are thermodynamically sensitive to charged-particle motion, which is normally a function of an equilibrium temperature of the SOC stack, rather than the non-equilibrium and preferential heating of high charge-to-mass-ratio particles like electrons or ionized hydrogen atoms as is provided in the current high-frequency embodiments.

It is contemplated herein that the embodied capability to induce preferential yet uniform heating of one electrode or other layers of a SOC electrolyte can introduce a wide array of possible advantages pertaining to both ion conductivity and catalytic behavior. For example, an induced Seebeck effect can be realized in such a scenario, whereby current carrier density within the electrolyte can be modified and even modulated by way of a thermal-gradient across the electrolyte or electrodes, in some cases such that a relatively higher gradient of charge or potential is created in the vicinity of the electrode-electrolyte interface's three-phase-boundary. Carrier density, effective carrier mobility, and electrical gradients within the electrolyte and electrodes can be modulated by both the associated phonon coupling of a modulated thermal gradient as well as by the voltage gradients induced by the embodied coupling of polyphase cycling (or pulsing) of the applied power and/or of an applied polyphase impedance used in a SOEC or SOFC system, in accordance with the polyphase embodiments.

Due to the sub-micrometer electrolyte thickness of the preferred embodiments, far high potential gradients and according carrier density gradients can be accomplished in the present embodiments, thereby allowing such effects to be entirely more functional and modulated at higher frequencies than in the case of the many-micrometer thicknesses of electrolyte layers in the prior art. The preferred hexagonal periodicity, or alternatively various other periodicity types (cubic, tetragonal, etc), of the interleaved, articulated grid-alloy foil structures of the various embodiments herein can also be specified to provide metamaterial-type interference in these various polyphase interactions so as to enhance a desired electrochemical interaction.

For example, a thyristor-based pulsing circuit utilized in conjunction with the 12-phase embodiments could deliver substantially square pulses in a left-handed (or right-handed) chiral delivery scheme about the SOC stack utilized in steam electrolysis, wherein electromagnetic currents derived from a resultant induced net current-flow might result in far more electronically-active component harmonics that are more capable to incite various enhanced, non-equilibrium, rates of reaction in any one of the various surface interactions of the SOC. Alternatively, a relatively simple rectified 3-phase waveform provides a convenient 6-phase rectified power signal that can efficiently deliver a biased 60-degree-advanced rotation of voltage gradients about the cell or stack. The cell-to-cell phase relationships can also be readily shifted for a variety of periodic or aperiodic voltage-sweep characteristics at the cell's electrochemical and material interfaces.

Advantages of the aforementioned polyphase embodiments are the ability to electronically and thermodynamically tailor a relatively uniform local environment across the vast surface area of the SOC stack. In addition, the sweeping nature provided by the rotational nature of the geometry and its polyphase embodiments is conducive to a variety of “drift” mechanisms whereby both charged species as well as the chemical potential created by movement of such charged species, are made to rotate, diffuse, and effectively drift around the annular track, particularly where constructed to provide relatively high mobility between the embodied sections (411) of the annular active region. Such “drift” created by the voltage sweeps can be further modified by magnet fields, either externally applied or through self-inductance. Given the preferred cylindrical aspect of the embodied SOC stacks, such applied magnetic fields may be utilized to enhance many forms of electronic interaction and electron-activity in the stack that would not be practical in less-symmetric stacks (e.g., square or oblong stacks) of the prior art.

It will be understood by those skilled in the art that the electrical connections for electrodes or counter-electrodes of the stack can be alternatively connected through the central manifold or through insulated posts in the sealing regions that provide contact to one polarity of the stack's cells. Whereas, such alternative positioning of electrical contacts may allow some advantage in further improving uniformity of conditions under a variety of specific impedance/materials and specific geometry, the preferred embodiments utilize peripheral contacts to maximize isolation from steam circuitry in the preferred and exemplary steam electrolysis application.

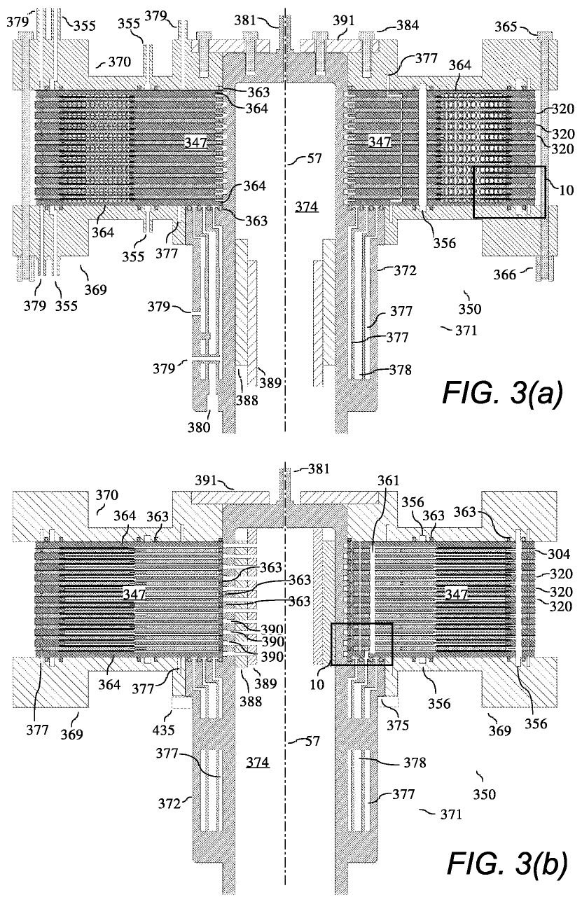

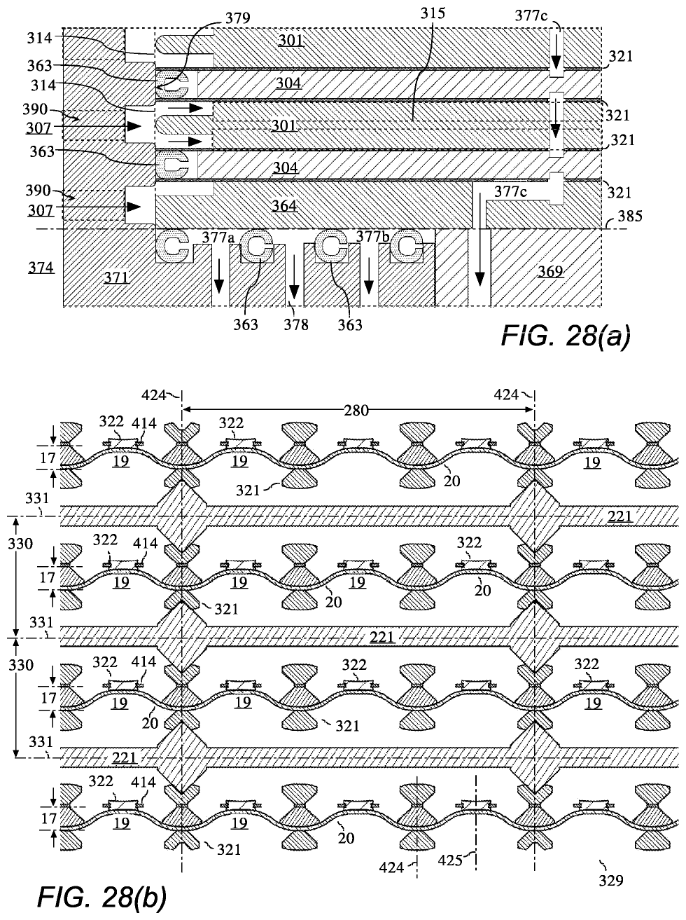

In the present embodiments, the inner seal interface of the cell-stack assembly to the center-tube module is exemplified at the region of the SOC stack assembly near its sealing plane (385) with the jacketed gas-passageways of the lower center-tube module, in FIG. 28(a), as close-captioned earlier in FIG. 3(b), comprises metallic ring-seal seating area (373) of the center-tube module wherein multiple metallic seals (363) are utilized to separate the multiple annular gas passageways embodied earlier. In the preferred HAFTA embodiments, compliant metallic seals prevent the steam, or other CPG, from interacting with the inner region of the annular O2-manifolds and creating a sealed CPG-containment space by sealing against opposing HAFTA modules.

The separator foil (321) provides (as outermost surface of the HAFTA module) preferably provides the sealing surface of the HAFTA module to the metallic ring-seals. The separator foil accordingly also provides the outer containment surface for completing the passageways of the the slotted CPG-inlet aperture structures (311), so that, at the inner diameter of the annular HAFTA module, the metallic ring-seals are preferably seated on the HAFTA module's separator foils opposite the separator's sealing surface to the edge-aperture structure (311)(314). In embodiments wherein the entire metal-alloy structure of the HAFTA module is monopolar and the separator is also an electrode/electrolyte assembly with outermost surface comprising the preferred insulator, the metallic ring-seals and HAFTA module are at substantially the same electrode potential, along with the center-tube module. In these latter “monopolar HAFTA” embodiments, both the outer separator foil (preferably less than 250 micrometers thick, and most preferably less than 150 micrometers thick) and the O2-manifolds are fabricated with the embodied insulator coating on their outer-facing surfaces, such that conduction between the HAFTA and O2-manifold modules is limited to ionic conduction through the electrolyte.

In the “bipolar HAFTA module” embodiments wherein the separator's metal-alloy structure is instead at the O2-modules counter-electrode potential, the separator is insulator-encapsulated at its inner diameter so as to not conduct the counter-electrode potential of the separator with the metallic ring-seals or the center-tube module. In these “bipolar HAFTA module” embodiments, the separator is also formed with the insulating layer on its inner surface that seals to the HAFTA manifold, so that it is disposed to operate at the O2-manifold's counter-electrode potential.

The various, electrochemically-passive, barrier layers, including insulator layers, of the invention are incorporated into the surfaces of the various components as indicated in conjunction with the various embodiments. In addition to the earlier-embodied barrier-layers that encapsulate the metal-alloy components, the preferred insulating layers are (XXX) is preferably formed on both the HAFTA manifold sealing surfaces (376) as well as onto the facing separator in the geometries wherein such insulator layer is required, such that the circulating CPG is not contacting an O2-side (designated the counter-electrode potential herein) conductor. The preferred insulating films are preferably in the range of 0.5-2.0 micrometers thick, and disposed so as to allow the O2-manifold and O2 modules (304) to be electrically insulated from the HAFTA manifolds as well as from the CPG carrying center-tube assembly, and the metal ring-seals. In the “bipolar HAFTA embodiments, it is preferred that the insulating film is also covering the external sealing surface of the center-tube module, in addition to its normal barrier-layer surface termination. Since the open region between metal seals and the adjacent O2 manifold inner diameter edge is preferably the innermost N2 purge passage ways (377a) of the HAFTA modules, the seal health is maintained from undesired condensates, whereas any seal failure is readily detected by monitoring the N2 gas composition.

As embodied, in FIG. 28(a), an inside stagger margin wherein the HAFTA module has an annular ID that is marginally smaller than that of the O2-module at the assembled stack ID provides an annular space for housing the preferred compliant C-ring metallic ring-seals (363) and providing the clearance both for the inner-most inert-gas passageway (377a) of the HAFTA manifold to circulated inert gas in this space; as well as a clearance such that the contained metallic C-seal (or alternatively any other compatible ring-seal) is disposed therein and compressed between the two neighboring HAFTA modules. In the preferred embodiments, the compliant metallic ring-seals are composed of a Pt-terminated Inconel 718, Inconel 750-x, or similarly-composed NI-alloy in this same composition range in order to provide reliable service life.

It is preferred that the compliant metallic seals (363) be operating at, and in electrical communication with, the electrical potential of center-tube module and the HAFTA manifold, and therefore insulated from the O2 manifold (304). Accordingly, the inner region of separator in the present embodiments is terminated on both faces with a vapor-deposited layer of the preferred magnesium-zirconate-type insulator discussed herein.

In the present preferred embodiments of the center-tube/stack interface, the ports (390) of the stack-interface portion of the center-tube module are thus disposed to provide a fluidic communication of the condensate-prone gas (CPG) into the according edge-input apertures (314) of the HAFTA manifold

As indicated previously, the preferred HAFTA embodiment are utilized in part so as to most effectively teach the various inventive embodiments set forth and are not intended to limit or restrict the various inventive structures and methods to devices operating in accordance with the HAFTA operation or principles, since many of the embodiments of the present disclosure are equally advantageous in operation of a wide variety SOC-based devices and systems.

In an alternative, non-HAFTA embodiment, a non-HAFTA, series-contacted SOC stack assembly is disclosed that is similar to the annular stacks disclosed in the previous referenced patent applications by same author, wherein structure and principles introduced in the present invention are utilized, in FIG. 28(b), in conjunction with an electrically series-connected stack composed primarily of the similar foil structures of before, and wherein only a single thin, bipolar manifold (221) is utilized in conjunction with single electrolyte/electrode assembly constructed in conjunction with these respective structures in accordance with their various preferred embodiments. The resulting UHD-SOC stack (339) is thus disposed for operation in the preferred annular arrangements using similar gas-channel methods so as to provide either SOFC or SOEC functions as a series-connected stack.

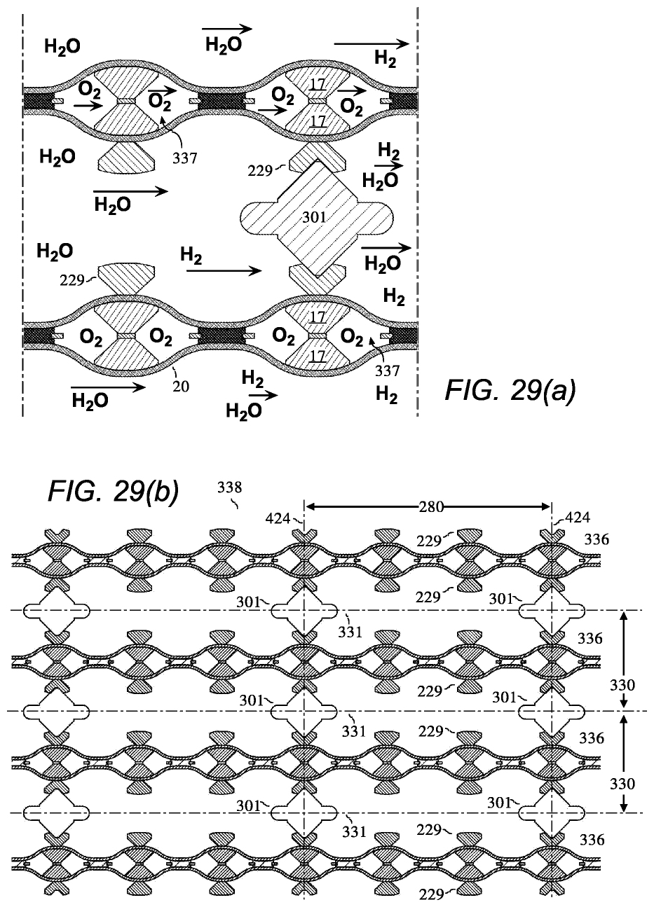

As an example of an alternative embodiment utilizing many of the same structures, methods and principles set forth herein, while still retaining HAFTA operating principles, an ultra-high-density stack construction, or, UHD-HAFTA stack assembly (338), in FIG. 29. In such embodiments, the

HAFTA cell thickness or pitch, is considerably smaller relative for the same scale of the pedestal spacing and spacing distance between ribs of manifold (280).

The present alternative UHD-HAFTA embodiments provide the same deterministic and controllable electrode/electrolyte assembly (30) structure discussed herein in conjunction with other embodiments, which provides substantially higher effective electrolyte cell area while still retaining much of the previously outlined construction, in FIG. 29(a)-(b). In the present embodiments, further reduction of the cell pitch/spacing is accomplished by utilizing the interior space (337) of the twinned, and specifically, symmetric embodiments of the electrolyte/electrode assembly (both assemblies of the twinned structure are symmetrically providing the same electrolyte/electrode electrochemical function) as the O2-side manifold, wherein this interior space also provides a monopolar O2-side manifold similar to previous embodiments. In the present embodiment, manifolding of O2 to and from the interior spaces (337) of the twinned electrolytes is performed by the same means utilized for creating passages in the thicker manifolds, wherein gas channels are formed by etched channels in the reinforcing foil and adjoining support structures (17) of the, now symmetric, twinned, roughly identical electrode/electrolyte assemblies.

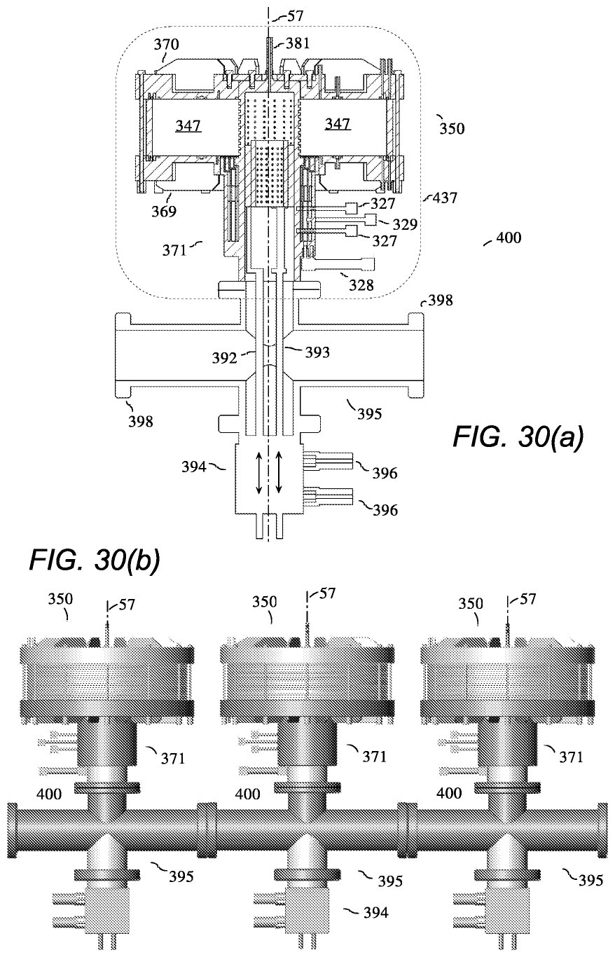

Since the center-tube and valve assemblies are disposed for handling relatively dangerous media such as steam or hydrocarbons, it is preferred that the linear valve assembly be integrated into the plumping that provides interconnect plumbing of such gaseous media to the center-tube assembly of the stack/center-tube assembly, wherein the valve motion drive, linear driven valve shuttles and this interconnect plumbing comprise a valve-shuttle and interconnection assembly (395). The overall SOC system disclosed, as an integrated SOC stack/center-tube/valve assembly (400), can thus be daisy chained via interconnect flanges (398) for high-volume installations, in FIG. 30(a-b). Such system-level embodiments will be further detailed in conjunction with the drawings in the following description.

What is claimed is:

1. An electrochemical device having solid electrolyte conductors, comprising:
a.) a thin metallic support structure comprising a substantially non-porous material, the structure having a first side and a second side, the structure patterned with a plurality of through-hole structures, the through-hole structures each having a hole interior surface extending between the first side and the second side;
b.) an electrolyte layer formed over the first side and hermetically attached to the support structure so that the electrolytic layer covering the through hole structures such that the electrolyte layer provides a hermetic barrier between a first gas adjacent the first side and a second gas adjacent the second side, the electrolyte layer thereby forming an active electrolyte region within each of the plurality of through-hole structures; and,
c.) electrode means formed over opposing sides of the electrolyte layer such that a harmonic frequency is generated by an applied electrical field, the harmonic frequency a higher frequency than the applied voltage, the harmonic frequency coupling to an electrochemical activity taking place roughly within the through-hole structures.

2. An electrochemical device having solid electrolyte conductors, comprising:
a.) a thin metallic support structure comprising a substantially non-porous material, the structure having a first side and a second side, the structure patterned with a plurality of through-hole structures, the through-hole structures each having a hole interior surface extending between the first side and the second side;
b.) an electrolyte layer formed over the first side and sealingly attached to the support structure so that the electrolytic layer covering the through hole structures so that the electrolyte layer provides a hermetic barrier between a first gas adjacent the first side and a second gas adjacent the second side, the electrolyte layer thereby forming a suspended region within each of the plurality of through-hole structures; and,
c.) electrode means formed over opposing sides of the electrolyte layer within each region such that electron current flow within the region is provided preferentially from the hole interior surface on the first side and preferentially through a current tap structure located at the center of the region on the second side.

3. A method of operating an electrochemical cell, comprising the steps:
a.) providing a planar electrochemical cell stack having a roughly annular aspect with a central axis wherein the annular aspect is formed by a plurality of planar electrochemical cells stacked so as to form a central cylindrical opening along the central axis;
b.) providing a cylindrical valve assembly within the central cylindrical opening, the cylindrical valve assembly comprising a piston-like element having a plurality of openings; and,
c.) providing means for positioning the piston-like element such that the piston-like element simultaneously actuates a plurality of local valve structures positioned so as to address each of the plurality of planar electrochemical cells so that a pressure differential is formed simultaneously between each planar electrochemical cell and a gas located within the central cylindrical opening.
